(19) United States
(12) Patent Application Publication
(10) Pub. No.: US 2015/0077310 A1
(43) Pub. Date: Mar. 19, 2015

(54) IMAGE DISPLAY APPARATUS, INFORMATION PROCESSING APPARATUS, INFORMATION PROCESSING METHOD, PROGRAM, AND INFORMATION PROCESSING SYSTEM

(71) Applicant: SONY CORPORATION, TOKYO (JP)

(72) Inventors: SHINJI INAMOTO, TOKYO (JP); NOBUHIRO OGAWA, TOKYO (JP); HIROYUKI AGA, TOKYO (JP); YOICHI YAGASAKI, TOKYO (JP)

(21) Appl. No.: 14/478,240

(22) Filed: Sep. 5, 2014

(30) Foreign Application Priority Data
Sep. 17, 2013 (JP) 2013-191346

(51) Int. Cl. G06F 3/14; H04W 4/00

(52) U.S. Cl. CPC G06F 3/1446; H04W 4/008; G09G 2300/026
USPC 345/1.3

(57) ABSTRACT

There is provided an image display apparatus, including: a display unit capable of displaying an image; a plurality of adjacent portions arranged on the display unit at a predetermined positional relation; senders capable of sending data via near field communication, the senders being arranged on at least two of the plurality of adjacent portions, respectively; and a receiver capable of receiving data via the near field communication from a sender of another image display apparatus, the receiver being arranged on at least one of the plurality of adjacent portions.

### CROSS REFERENCE TO RELATED APPLICATIONS

This application claims the benefit of Japanese Priority Patent Application JP 2013-191346 filed Sep. 17, 2013, the entire contents of which are incorporated herein by reference.

### BACKGROUND

The present disclosure relates to an information processing system, an information processing apparatus, an information processing method, a program, and an image display apparatus capable of controlling a system including a plurality of arrayed apparatuses such as a multi-display system.

According to Japanese Patent Application Laid-open No. 2012-83403, a multi-screen display apparatus is in widespread use. According to a multi-screen display apparatus, a plurality of monitors (unit monitors) are arranged in a matrix, and one image is displayed as a whole. According to the technology disclosed in Japanese Patent Application Laid-open No. 2012-83403, the positions of a plurality of unit monitors arranged in a matrix may be determined without depending on operations input by a user (Japanese Patent Application Laid-open No. 2012-83403, paragraphs [0002], [0008], etc.).

As shown in FIG. 3A of Japanese Patent Application Laid-open No. 2012-83403, a signal sender 204 is provided on each of four side surfaces of a unit monitor 110. The signal senders 204 send determination signals to the four unit monitors 110 adjacent in four directions, respectively. Moreover, a signal receiver 206 is provided on each of the four side surfaces of the unit monitor 110. The signal receiver 206 receives a determination signal sent from another unit monitor 110. The positions of the plurality of unit monitors 110 are determined based on the determination signals received by the signal receivers 206 (Japanese Patent Application Laid-open No. 2012-83403, paragraphs [0023], [0024], [0060], etc.).

### SUMMARY

It is desirable to provide a useful technology capable of managing the positional relation of a plurality of apparatuses, which are arrayed in use, in a system such as the above-mentioned multi-screen display apparatus.

In view of the above-mentioned circumstances, it is desirable to provide a useful information processing system, information processing apparatus, information processing method, program, and image display apparatus capable of managing the arrangement status of a plurality of apparatuses.

According to an embodiment of the present technology, there is provided an image display apparatus including a display unit, a plurality of adjacent portions, senders, and a receiver.

The display unit is capable of displaying an image.

The plurality of adjacent portions are arranged on the display unit at a predetermined positional relation.

The senders are capable of sending data via near field communication, the senders being arranged on at least two of the plurality of adjacent portions, respectively.

The receiver is capable of receiving data via the near field communication from a sender of another image display apparatus, the receiver being arranged on at least one of the plurality of adjacent portions.

According to the image display apparatus, a display unit includes a plurality of adjacent portions. Moreover, the senders and the receiver capable of establishing near field communication are arranged on the plurality of adjacent portions. With this configuration, the receiver is capable of receiving data via near field communication from a sender arranged on an adjacent portion of another image display apparatus. As a result, it is possible to manage the arrangement status of the plurality of image display apparatuses based on pieces of data received by each receiver.

Each of the senders may be capable of sending the data within an area including a vicinal adjacent portion, the vicinal adjacent portion being an adjacent portion in the vicinity of the sender out of a plurality of adjacent portions of the other image display apparatus. In this case, the receiver may be capable of receiving data from the sender of the other image display apparatus within the area including the vicinal adjacent portion, the sender being arranged on the vicinal adjacent portion.

According to the image display apparatus, each sender or receiver is capable of establishing near field communication within an area including a vicinal adjacent portion. The receiver receives data from a sender arranged on a vicinal adjacent portion in the vicinity of the adjacent portion on which the receiver is arranged. It is possible to determine, based on pieces of data received by each receiver, the image display apparatus including the vicinal adjacent portion on which the sender is arranged, and the position of the other image display apparatus that the adjacent portion corresponds to. As a result, it is possible to calculate and manage the arrangement status of a plurality of image display apparatuses.

The display unit may be a polygon. In this case, each of the plurality of adjacent portions may be a vertex portion of the polygon. In this case, it is possible to reduce a burden of setup of a plurality of adjacent portions.

The display unit may be a rectangle. In this case, the senders may be arranged on four corners, the four corners being the plurality of adjacent portions. Moreover, the receiver may be arranged on at least a predetermined first corner out of the four corners.

As described above, the receiver may be arranged on the predetermined first corner, and the arrangement status may be calculated.

The receiver may be at least arranged on each of the first corner and a second corner out of the four corners, the second corner being diagonal from the first corner.

As described above, the receivers may be arranged on the first and second corners, and the arrangement status may be calculated.

The receiver may be arranged on each of the four corners.

As described above, the receivers may be arranged on the four corners, and the arrangement status may be calculated.

The display unit may be a rectangle. In this case, the receiver may be at least arranged on a predetermined first corner out of four corners, the four corners being the plurality of adjacent portions. Moreover, the senders may be arranged on two corners out of three corners excluding the first corner out of the four corners.

As described above, the receiver may be arranged on the predetermined first corner, and the sender may be arranged on two other corners. With this configuration, also, it is possible to calculate the arrangement status.

The display unit may have its top and bottom in use, and the tops of the display units of the image display apparatus and the other image display apparatus may come to the upper side, and the bottoms come to the lower side.

If the display unit is arranged upside down, it is possible to detect the arrangement error based on data received by each receiver.

The display unit may have a long-side direction and a short-side direction, the display unit being capable of being used right side up and upside down, the short-side direction being a vertical direction. In this case, the receiver may be arranged on each of the first and second corners.

As described above, even if the display screen is capable of being used right side up and upside down, it is possible to calculate the arrangement status.

The image display apparatus may further include a detector capable detecting an arrangement direction.

As a result, it is possible to calculate the arrangement status based on orientation information easily.

The senders may be RFID (Radio Frequency IDentification) tags, and the receiver may be an RFID reader.

The configuration of an RFID tag or a reader is relatively simple, and costs for components are low. Because of this, it is possible to prevent the configuration of a unit apparatus from being complicated, and to reduce costs.

According to an embodiment of the present technology, there is provided an information processing apparatus capable of controlling at least part of operations of a plurality of unit apparatuses, each of the plurality of unit apparatuses including a plurality of adjacent portions, senders, and a receiver.

The plurality of adjacent portions have a predetermined positional relation.

The senders are capable of sending data via near field communication, the senders being arranged on at least two of the plurality of adjacent portions, respectively.

The receiver is capable of receiving data via the near field communication from a sender of another unit apparatus, the receiver being arranged on at least one of the plurality of adjacent portions.

The information processing apparatus includes a data receiver and a calculator.

The data receiver is configured to receive the data, the receiver of each of the plurality of unit apparatuses receiving the data from the sender via the near field communication.

The calculator is capable of calculating an arrangement status of the plurality of unit apparatuses based on the received data.

The information processing apparatus is capable of calculating and managing the arrangement status of the plurality of unit apparatuses based on data received by the receiver of each unit apparatus.

Each of the senders of each of the plurality of unit apparatuses may be capable of sending the data via the near field communication within an area including a vicinal adjacent portion, the vicinal adjacent portion being an adjacent portion in the vicinity of the sender out of a plurality of adjacent portions of the other unit apparatus.

The receiver of each of the plurality of unit apparatuses may be capable of receiving data from the sender of the other unit apparatus via the near field communication within the area including the vicinal adjacent portion, the sender being arranged on the vicinal adjacent portion. In this case, the information processing apparatus may further include a determining unit.

The determining unit is capable of determining the other unit apparatus including the vicinal adjacent portion on which the sender is arranged based on the data received by the data receiver, the vicinal adjacent portion being in the vicinity of the adjacent portion on which the receiver is arranged, and determining a position of the vicinal adjacent portion on which the sender is arranged out of the plurality of adjacent portions of the other unit apparatus.

The calculator may be capable of calculating an arrangement status of the plurality of unit apparatuses based on a determination result of the other unit apparatus including the vicinal adjacent portion determined by the determining unit, and based on a determination result of the position of the vicinal adjacent portion determined by the determining unit.

The determining unit of the information processing apparatus is capable of determining, based on pieces of data received by each receiver, the image display apparatus including the vicinal adjacent portion on which the sender is arranged, and the position of the other image display apparatus that the adjacent portion corresponds to. It is possible to calculate and manage the arrangement status of a plurality of image display apparatuses based on the determination results.

Each of the plurality of unit apparatuses may have its top and bottom in use, and the tops of the plurality of unit apparatuses may come to the upper side, and the bottoms come to the lower side. In this case, the information processing apparatus may further include a detector.

The detector is capable of detecting an upside-down unit apparatus out of the plurality of unit apparatuses based on the determination result determined by the determining unit.

With this configuration, it is possible to detect an arrangement error, wrong arrangement, and the like promptly.

Each of the plurality of unit apparatuses may include a detector capable detecting an arrangement direction.

In this case, the calculator may be capable of calculating an arrangement status of the plurality of unit apparatuses based on the arrangement direction of each of the plurality of unit apparatuses detected by the detector.

As described above, the orientation of each unit apparatus may be calculated. It is possible to calculate the arrangement status easily based on the orientation information.

According to an embodiment of the present technology, there is provided an information processing method executed by a computer capable of controlling at least part of operations of the plurality of unit apparatuses, the information processing method including:

receiving the data, the receiver of each of the plurality of unit apparatuses receiving the data from the sender via the near field communication; and

calculating an arrangement status of the plurality of unit apparatuses based on the received data.

According to an embodiment of the present technology, there is provided a program, causing a computer to process information, the computer being capable of controlling at least part of operations of a plurality of unit apparatuses, the program causing the computer to execute the steps of:

receiving the data, the receiver of each of the plurality of unit apparatuses receiving the data from the sender via the near field communication; and
calculating an arrangement status of the plurality of unit apparatuses based on the received data.

According to an embodiment of the present technology, there is provided an information processing system including: a plurality of unit apparatuses; and a control apparatus capable of controlling at least part of operations of the plurality of unit apparatuses.

Each of the plurality of unit apparatuses includes a plurality of adjacent portions, a sender, and a receiver. The plurality of adjacent portions have a predetermined positional relation.

The senders are capable of sending data via near field communication, the senders being arranged on at least two of the plurality of adjacent portions, respectively.

The receiver is capable of receiving data via the near field communication from a sender of another unit apparatus, the receiver being arranged on at least one of the plurality of adjacent portions.

The control apparatus includes a data receiver and a calculator.

The data receiver is configured to receive the data, the receiver of each of the plurality of unit apparatuses receiving the data from the sender via the near field communication.

The calculator is capable of calculating an arrangement status of the plurality of unit apparatuses based on the received data.

As described above, according to the present technology, it is possible to provide a useful information processing system, information processing apparatus, information processing method, program, and image display apparatus capable of managing the arrangement status of a plurality of unit apparatuses. Note that the above-mentioned effects are not necessarily be attained, but any effect described in the present disclosure may be attained.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a diagram schematically showing a configuration example of an image display system according to a first embodiment;

FIG. 2 is a functional block diagram illustrating an image display apparatus, which is configured to send and receive tag information;

FIG. 3 is a block diagram schematically showing a configuration example of hardware of an integration control apparatus;

FIG. 4 is a block diagram schematically showing a functional configuration example of the integration control apparatus;

FIGS. 5A and 5B are diagrams illustrating process of calculating an arrangement status by the integration control apparatus;

FIGS. 6A and 6B are diagrams each schematically showing an arrangement example in which an overall shape is not rectangular;

FIG. 7 is a diagram showing a state where an image display apparatus is arranged upside down;

FIGS. 8A and 8B are diagrams each schematically showing an image display apparatus or image display apparatuses of a second embodiment;

FIGS. 9A and 9B are diagrams each illustrating an arrangement example, in which each image display apparatus includes one reader;

FIGS. 10A and 10B are diagrams each illustrating an arrangement example, in which each image display apparatus includes one reader;

FIG. 11 are diagrams each illustrating an arrangement example, in which each image display apparatus includes one reader;

FIGS. 12A and 12B are diagrams showing a state where an image display apparatus is arranged upside down;

FIG. 13 is a diagram schematically showing an arrangement status according to an example of a third embodiment;

FIG. 14 is a flowchart showing the flow of calculation of an arrangement status according to this embodiment;

FIG. 15 is a flowchart showing the flow of check_grid(cur);

FIGS. 16A and 16B are diagrams showing arrangement statuses having the positional relation of FIG. 13 and having different orientations as a whole;

FIGS. 17A and 17B are diagrams each illustrating grids adjacent to each other in this embodiment and an example of a method of determining their orientations;

FIGS. 18A and 18B are diagrams each illustrating grids adjacent to each other in this embodiment and an example of a method of determining their orientations;

FIG. 19 is a diagram schematically showing an arrangement status according to a fourth embodiment of the present technology;

FIG. 20 is a diagram schematically showing an arrangement status according to a fifth embodiment of the present technology; and

FIGS. 21A, 21B, and 21C are diagrams each schematically showing an arrangement status according to a sixth embodiment of the present technology.

### DETAILED DESCRIPTION OF EMBODIMENTS

Hereinafter, embodiments of the present disclosure will be described with reference to the drawings.

### First Embodiment

### [Configuration of Image Display System]

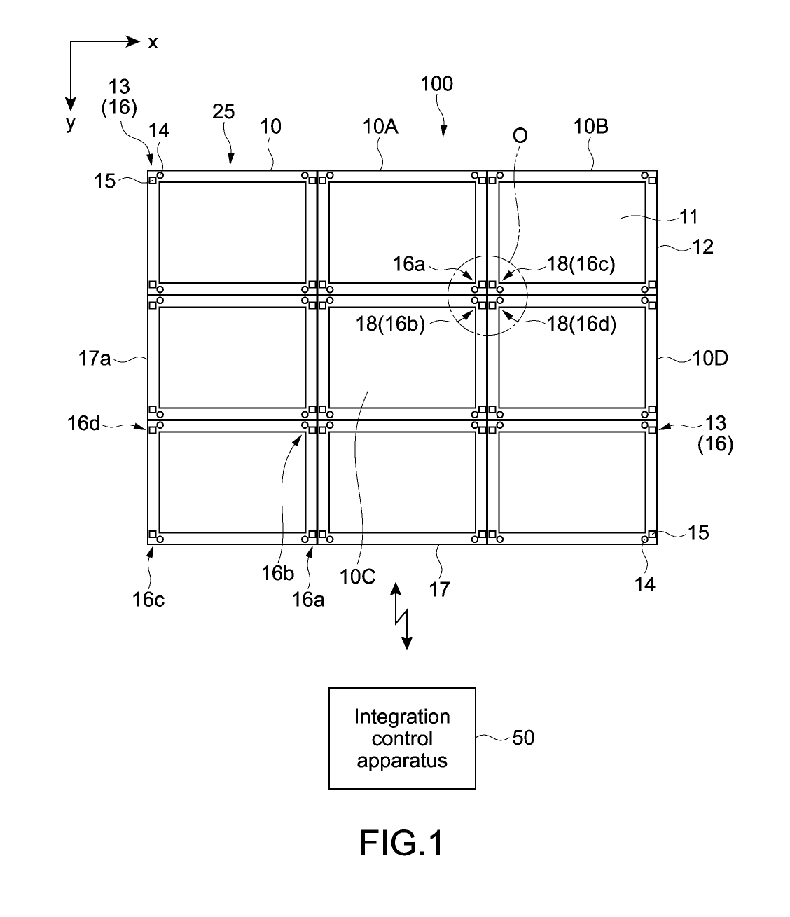

FIG. 1 is a diagram schematically showing a configuration example of an image display system, i.e., an information processing system, according to a first embodiment of the present technology. An image display system 100 includes a plurality of image display apparatuses 10 and an integration control apparatus 50. The integration control apparatus 50 is capable of controlling at least part of operations of the plurality of image display apparatuses 10. Each of the plurality of image display apparatuses 10 connects to the integration control apparatus 50, and they are capable of communicating with each other.

Each of the plurality of image display apparatuses 10 may connect to the integration control apparatus 50 in any mode, in any method, and the like. Each of the plurality of image display apparatuses 10 may connect to the integration control apparatus 50 wirelessly or wiredly. Moreover, for example each of the plurality of image display apparatuses 10 may connect to the integration control apparatus 50 via a network such as a LAN (Local Area Network) or a WAN (Wide Area Network). Alternatively, an arbitrary configuration for connection may be employed.

The plurality of image display apparatuses 10 are capable of being used where they are arranged two-dimensionally. If the plurality of image display apparatuses 10 are arranged two-dimensionally, it is possible to display an image on a large screen. In this embodiment, the plurality of image display apparatuses 10 are image display apparatuses of the same kind having the same function. Alternatively, the plurality of image display apparatuses 10 may be image display apparatuses of different kinds having different functions. In this embodiment, the plurality of image display apparatuses 10 correspond to “a plurality of unit apparatus”.

As shown in FIG. 1, each image display apparatus 10 is rectangular seen in the front direction. Moreover, the image display apparatuses 10 have the same size. The image display apparatus 10 includes a display unit 25 capable of displaying an image. The display unit 25 includes a display screen 11 and a frame 12. The frame 12 is a rim surrounding the rim of the display screen 11. The shape of the display unit 25 is the outer shape of the image display apparatus 10. In other words, in this embodiment, the display unit 25 is rectangular.

Typically the shape of the display unit 25 is determined by the shape of the frame 12. For example if an arbitrarily polygonal frame 12 is mounted on the rim of the rectangular display screen 11, the display unit 25 is a polygon. The shape of the display screen 11 may be similar to or different from the shape of the frame 12. Note that the frame 12 is not necessarily arranged so that the frame 12 may surround the entire display screen 11.

The image display apparatus 10 includes a built-in controller (not shown). The controller includes for example a CPU (Central Processing Unit), a ROM (Read Only Memory), a RAM (Random Access Memory), and the like. A controller program is stored in the ROM. The CPU loads the controller program in the RAM, and executes the controller program. As a result, the CPU controls mechanisms of the image display apparatus 10. For example in response to an instruction from the integration control apparatus 50, a partial image in a large image is displayed on the display screen 11. The configuration of the controller is not limited. The controller may have any arbitrary hardware and software. Alternatively, an arbitrary configuration for displaying an image may be used.

Moreover, the image display apparatus 10 includes a plurality of adjacent portions 13, RFID (Radio Frequency Identification) tags 14 (hereinafter simply referred to as tags 14), and RFID readers 15 (hereinafter simply referred to as readers 15). The tags 14 function as senders, and are arranged on the plurality of adjacent portions 13, respectively. The readers 15 function as receivers, and are arranged on the plurality of adjacent portions 13, respectively.

The plurality of adjacent portions 13 and the display unit 25 have a predetermined positional relation. Typically, four corners 16 of the rectangular frame 12 are determined as the plurality of adjacent portions 13. The four corners 16 includes a lower-right corner 16a, a upper-right corner 16b, a lower-left corner 16c, and the upper-left corner 16d having a predetermined positional relation. It is possible to determine the positional relation of the adjacent image display apparatuses 10 based on the adjacent corners 16.

The plurality of adjacent portions 13 may be different from the four corners 16 as long as it is possible to determine the positional relation of the image display apparatuses 10. For example center portions of four sides 17 of the frame 12 may be used as the plurality of adjacent portions 13, respectively. The plurality of adjacent portions 13 may be at other positions.

Note that if the outer shape (shape of display unit 25) of the image display apparatus 10 is a polygon seen in the front direction, vertex portions of the polygon may be determined as the plurality of adjacent portions 13. The vertex portion means a portion in the vicinity of each vertex. With this configuration, it is possible to reduce a burden when setting the plurality of adjacent portions 13. Note that a polygon includes not only a sharply-angled polygon but also a rather obtuse-angled polygon and a polygon having round corners.

The tag 14 and the reader 15 are arranged on each corner 16 where a predetermined area is a communicable area O. With reference to the lower-right corner 16a of the image display apparatus 10A of FIG. 1, the communicable area O will be described. The image display apparatuses 10B to 10D are arranged around the image display apparatus 10A, and have the corners 16, respectively. The corners 16 in the vicinity of the lower-right corner 16a of the image display apparatus 10A are referred to as vicinal corners (vicinal adjacent portions) 18, where the image display apparatuses 10A to 10D are two-dimensionally arranged. In the example of FIG. 1, the lower-left corner 16c of the image display apparatus 10B, the upper-right corner 16b of the image display apparatus 10C, and the upper-left corner 16d of the image display apparatus 10D are the vicinal corners 18. In this embodiment, the area (area of dotted circle) having the vicinal corners 18 is the communicable area O.

The tag 14 is a sender capable of sending data within an area including the vicinal corners 18 via near field communication. Moreover, the reader 15 is a receiver capable of receiving data from the tags 14 of other image display apparatuses 10, the tags 14 being arranged on the vicinal corners 18, within the area including the vicinal corners 18 via near field communication. With this configuration, each tag 14 sends data on each vicinal corner 18 to the reader 15, whereby it is possible to determine the positional relation of the vicinal corners 18.

As described above, according to the present technology, a sender and a receiver are capable of communicating with each other via near field communication within the communicable area O, i.e., an area including the vicinal corners 18. Moreover, communication directionality of a plurality of senders and receivers is low, and they are capable of communicating with each other wirelessly within the communicable area O. Typically for example the RFID tags 14 and the RFID readers 15 may be used as such senders and receivers.

The size of the communicable area O is not specifically limited. The size of the communicable area O may be arbitrarily set as long as near field communication is performed within an area including the vicinal corners 18. In other words, the communicable area of the tags 14 and the readers 15 may be arbitrarily set as long as wireless communication is enabled within a predetermined distance or less.

Typically each of the tags 14 and the readers 15 has a communicable distance of about several mm to several tens of cm. The communicable distance may be set depending on gaps between the two-dimensionally arranged image display apparatuses 10, the width of the frames 12, and the like. For example if the communicable distance is equal to or shorter than the short side 17a out of the four sides of FIG. 1, near field communication is established within an area including the vicinal corners 18. In other words, the communicable area O may be set based on the size of the image display apparatus 10 or the like.

The configuration of the tag 14 and the configuration of the reader 15 are not specifically limited. In this embodiment, passive tags are used. A passive tag uses radio waves from the reader 15 as an energy source and thus operate. With this configuration, the configuration of the system may be simplified. Alternatively, active tags or semi-active tags (having properties of both tags) may be used. Moreover, a communication method is not limited, and an arbitrary communication method such as a radio wave method or an electromagnetic induction method may be used.

As shown in FIG. 1, in this embodiment, the tags 14 and the readers 15 are arranged on all the four corners 16, respectively. Each tag 14 is capable of wirelessly sending information on the ID of the image display apparatus 10 and the position (lower-right, upper-right, lower-left, or upper-left) of the tag 14. For example, the tag 14, which is arranged on the lower-left corner 16c of the image display apparatus 10B of FIG. 1, sends information on the ID of the image display apparatus 10B and on the lower-left position. The readers 15 on the vicinal corners 18 receive the tag information.

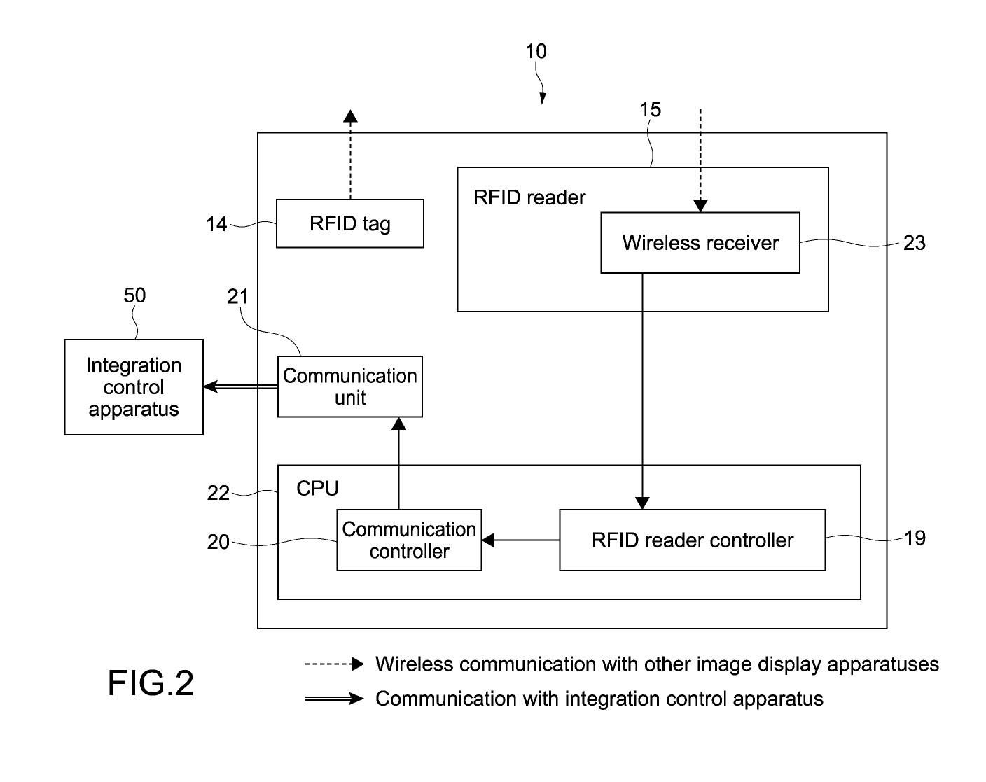

FIG. 2 is a functional block diagram showing the image display apparatus 10, which is configured to send and receive tag information. The image display apparatus 10 includes the tag 14, the reader 15, a reader controller 19, a communication controller 20, and a communication unit 21. A CPU 22 executes predetermined programs to thereby realize the reader controller 19 and the communication controller 20. The communication unit 21 is a communication apparatus configured to communicate with the integration control apparatus 50. For example the communication unit 21 includes a modem capable of connecting to a LAN, a WAN, and the like, a router, and the like. The communication unit 21 may be independent of the image display apparatus 10.

A wireless receiver 23 of the reader 15 receives communication from the tags 14 of the other image display apparatuses 10 arranged on the vicinal corners 18. Moreover, the reader 15 obtains tag information on the tags 14. The reader controller 19 outputs the tag information obtained by the reader 15 to the communication controller 20. The communication controller 20 sends the tag information to the integration control apparatus 50 via the communication unit 21. The integration control apparatus 50 manages all the plurality of image display apparatuses 10. As described above, each image display apparatus 10 sends tag information obtained by each reader 15 to the integration control apparatus 50 via each communication unit 21.

The integration control apparatus 50 combines pieces of tag information obtained from all the image display apparatuses 10, to thereby calculate the overall shape of the plurality of two-dimensionally arranged image display apparatuses 10 and the positions of the image display apparatuses 10. To display an image on the display screens 11 of the image display apparatuses 10, the integration control apparatus 50 sends drawing instructions to the image display apparatuses 10 based on the positions and directions of the image display apparatuses 10.

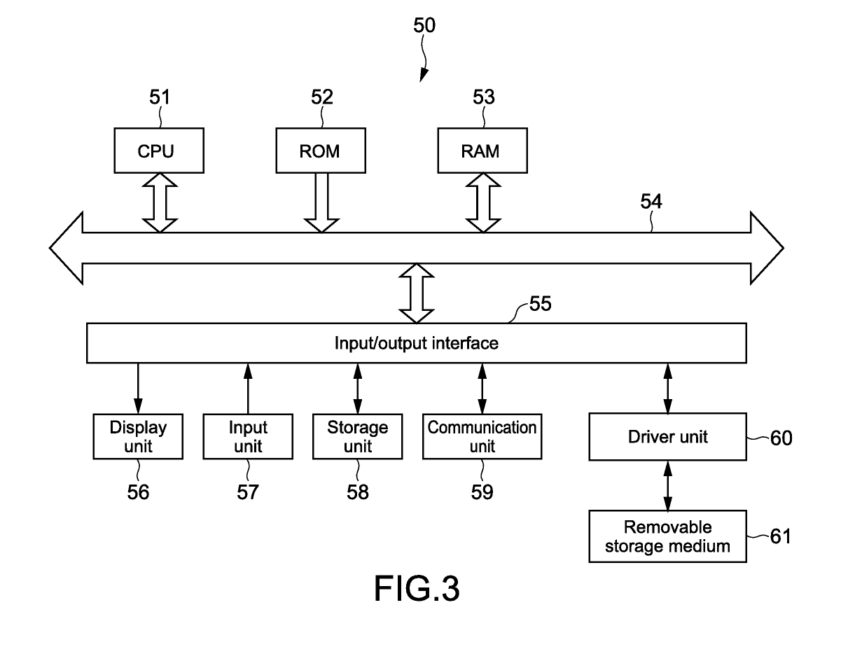

The integration control apparatus 50 is any kind of computer such as for example a PC (Personal Computer). FIG. 3 is a block diagram schematically showing a configuration example of hardware of the integration control apparatus 50. The integration control apparatus 50 functions as a control apparatus capable of controlling at least part of operations of a plurality of unit apparatuses of the image display system 100 of this embodiment. Moreover, the integration control apparatus 50 also functions as an information processing apparatus of the present technology. Each image display apparatus 10 may function as an information processing apparatus of the present technology, and may have a configuration approximately similar to the hardware configuration of FIG. 3.

The integration control apparatus 50 includes a CPU 51, a ROM 52, a RAM 53, an input/output interface 55, and a bus 54 connecting them. A display unit 56, an input unit 57, a storage unit 58, a communication unit 59, a driver unit 60, and the like connect to the input/output interface 55.

The display unit 56 is for example a liquid crystal display device, an EL (Electro-Luminescence) display device, a CRT (Cathode Ray Tube) display device, or the like. The input unit 57 is an operating device such as for example a controller, a pointing device, a keyboard, or a touchpad. If the input unit 57 includes a touchpad, the touchpad and the display unit 56 may be integrally structured.

The storage unit 58 is a nonvolatile storage device such as for example an HDD (Hard Disk Drive), a flash memory, or another solid-state memory. The driver unit 60 is a device capable of driving a removable storage medium 61 such as for example an optical storage medium, a floppy (registered trademark) disk, a magnetic storage tape, or a flash memory. Meanwhile, in most cases, the storage unit 58 is a device built in the integration control apparatus 50, and mainly drives a non-removable storage medium.

The communication unit 59 is a communication device configured to communicate with other devices. The communication unit 59 is a modem capable of connecting to a LAN, a WAN, or the like, a router, or the like. The communication unit 59 may perform wired and wireless communication. In most cases, the communication unit 59 is independent of the integration control apparatus 50. In this embodiment, the communication unit 59 functions as a data receiver. The readers 15 of the plurality of image display apparatuses 10 receive tag information (data) from the tag 14 via wireless communication. The data receiver receives the tag information (data).

The integration control apparatus 50 has the above-mentioned hardware configuration. Software stored in the storage unit 58, the ROM 52, or the like and the hardware resources of the integration control apparatus 50 cooperate, whereby the integration control apparatus 50 processes information. Specifically, a program configuring software is stored in the storage unit 58, the ROM 52, or the like. The CPU 51 loads the program in the RAM 53, and executers the program, whereby information is processed.

For example the program is stored in a storage medium, and is installed in the integration control apparatus 50. Alternatively, the program is installed in the integration control apparatus 50 via a global network or the like. Moreover, a program may cause the integration control apparatus 50 to process information in order in time series. Alternatively, a program may cause the integration control apparatus 50 to process information in parallel as necessary (e.g., when program is called).

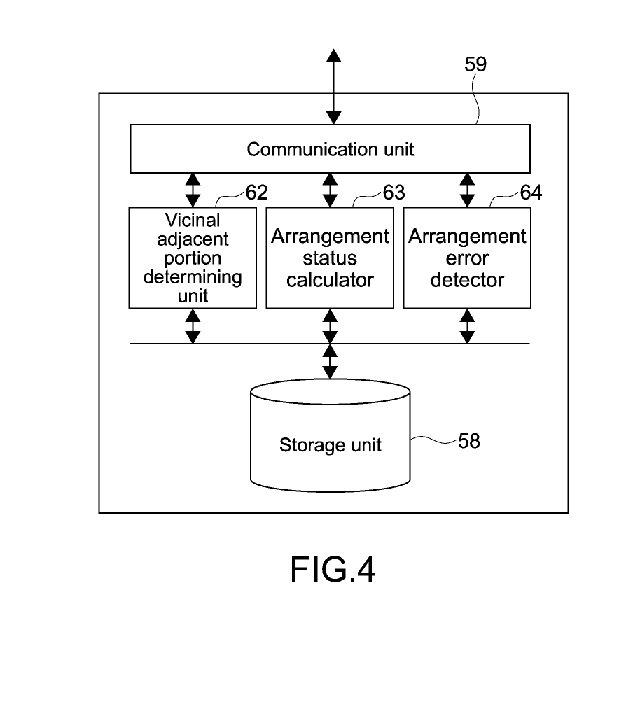

FIG. 4 is a block diagram schematically showing a functional configuration example of the integration control apparatus 50. The CPU 51 of FIG. 3 executes a predetermined program, whereby software blocks (i.e., vicinal adjacent portion determining unit 62, arrangement status calculator 63, and arrangement error detector 64) are realized.

The vicinal adjacent portion determining unit (hereinafter simply referred to as determining unit 62) determines the positional relation of adjacent portions based on pieces of tag information received from the readers 15. In other words, the determining unit 62 is capable of determining an image display apparatus 10 having a vicinal corner 18 on which a tag 14 is arranged, which is in the vicinity of the corners 16 on which the readers 15 are arranged. Moreover, the determining unit 62 is capable of determining the position of the vicinal adjacent portion 18 on which the tag 14 is arranged out of the corners 16 of the determined image display apparatus 10.

With reference to the lower-right corner 16a of the image display apparatus 10A of FIG. 1, processing executed by the determining unit 62 will be described. The reader 15 is arranged on the corner 16a of the image display apparatus 10A, and receives pieces of tag information. The determining unit 62 obtains the pieces of tag information. Based on the pieces of tag information, the determining unit 62 determines the image display apparatuses 10B to 10D each having the vicinal corner 18 in the vicinity of the corner 16a. Moreover, the determining unit 62 determines the positions of the corners 16 of the image display apparatuses 10B to 10D that the vicinal corners 18 correspond to. In other words, the determining unit 62 determines that the vicinal adjacent portions 18 are the lower-left corner 16c of the image display apparatus 10B, the upper-right corner 16b of the image display apparatuses 10C, and the upper-left corner 16d of the image display apparatus 10D.

The arrangement status calculator 63 (hereinafter simply referred to as calculator 63) is capable of calculating the arrangement status of the plurality of image display apparatuses 10 based on the pieces of tag information received from the readers 15. Specifically, the calculator 63 is capable of calculating the arrangement status of the plurality of image display apparatuses 10 based on the result (image display apparatuses 10 including vicinal adjacent portions 18) and the result (positions of vicinal adjacent portions 18) determined by the determining unit 62.

The arrangement error detector 64 (hereinafter simply referred to as detector 64) is capable of detecting an upside-down image display apparatus 10 out of the plurality of image display apparatuses 10 based on the results determined by the determining unit 62. The display unit 25 of the image display apparatus 10 of this embodiment has its top and bottom in use. When the image display apparatuses 10 are arranged two-dimensionally, the tops of the display units 25 of the image display apparatuses 10 come to the upper side, and the bottoms come to the lower side. For example in the example of FIG. 1, the plurality of image display apparatuses 10 are arranged in which the y direction is the vertical direction and the direction from bottom to top is the positive direction along the y axis. At this time, the detector 64 detects an upside-down image display apparatus 10.

[Operation of Image Display System]

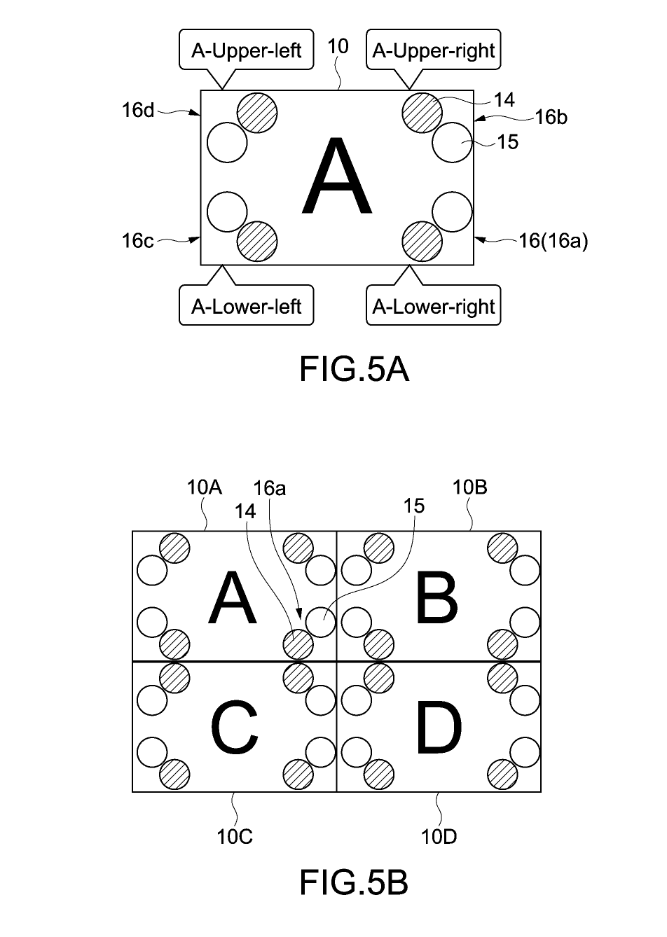

As an operation of the image display system 100 of this embodiment, process of calculating an arrangement status by the integration control apparatus 50 will mainly be described. FIGS. 5A and 5B are diagrams illustrating the process. As shown in the example of FIGS. 5A and 5B, the four image display apparatuses 10A to 10D having IDs (A, B, C, and D), respectively, are arranged.

Each of the four corners 16 of each image display apparatus 10 has the tag 14 and the reader 15. Each tag 14 sends tag information. The tag information is information on the ID of the image display apparatus 10, and the position (lower-right, upper-right, lower-left, or upper-left) of the tag 14. Hereinafter the tag information will be referred to as the combination of (ID, tag position). For example the tag 14 of the lower-right corner 16a of the image display apparatus 10A sends tag information (A, lower-right). The tag 14 of the upper-left corner 16d of the image display apparatus 10D sends tag information (D, upper-left).

The integration control apparatus 50 refers to pieces of tag information obtained by a reader 15 of a predetermined corner of a predetermined image display apparatus out of the four image display apparatuses 10. In the example of FIGS. 5A and 5B, the integration control apparatus 50 refers to pieces of tag information obtained by the reader 15 of the lower-right corner 16a of the image display apparatus 10A. The reader 15 receives tag information (B, lower-left), tag information (C, upper-right), and tag information (D, upper-left). The determining unit 62 determines the positional relation of the corners 16 based on those pieces of tag information. The calculator 63 calculates the arrangement status based on those pieces of tag information as follows.

Tag information (B, lower-left): the image display apparatus 10B is arranged at the right of the image display apparatus 10A.

Tag information (C, upper-right): the image display apparatus 10C is arranged at the bottom of the image display apparatus 10A.

Tag information (D, upper-left): the image display apparatus 10D is arranged at the lower-right of the image display apparatus 10A.

The arrangement status is two-by-two (arrangement status of FIG. 5B), and the overall shape is rectangular.

An arbitrary image display apparatus may be selected as the predetermined image display apparatus. The image display apparatus may be previously selected. Alternatively, for example the image display apparatus 10 connecting to the integration control apparatus 50 at first when the image display apparatuses 10 are arranged two-dimensionally may be selected as the predetermined image display apparatus. Moreover, the predetermined corner 16, whose pieces of tag information will be referred to, may not be the lower-right corner 16a. A corner 16 at an arbitrary position may be selected.

If the reader 15 of a predetermined corner does not obtain tag information (for example reader 15 of upper-left corner 16d of image display apparatus 10A, etc.) or if the arrangement status is not defined based on the obtained tag information (for example reader 15 of lower-left corner 16c of image display apparatus 10A, etc.), the integration control apparatus 50 refers to tag information obtained by the reader 15 of another corner 16. In this case, a method of selecting another corner 16 may be determined. For example, a method of selecting the adjacent corner 16 clockwise may be employed arbitrarily.

Note that the determining unit 62 may determine the overall positional relation of the corners 16 based on the pieces of tag information obtained from all the reader 15. The calculator 63 may calculate the arrangement status based on some pieces of information on the determination result. Meanwhile, the determining unit 62 may determine the overall positional relation, and the calculator 63 may calculate the arrangement status before referring to tag information. A single block may be configured to function as the determining unit 62 and the calculator 63 of FIG. 4.

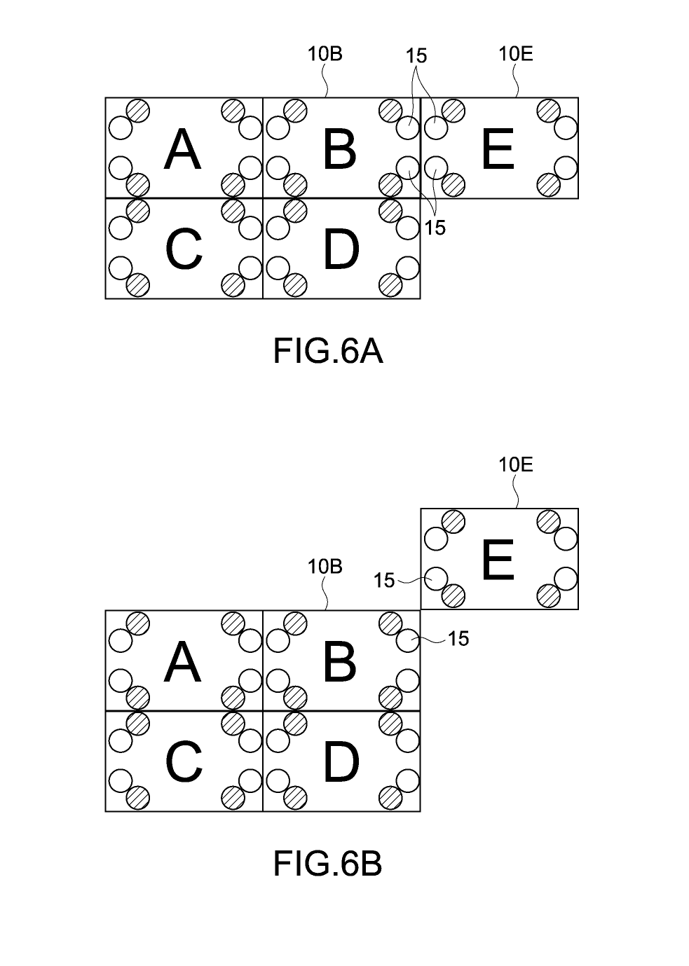

FIGS. 6A and 6B are diagrams each schematically showing an arrangement example in which the overall shape is not rectangular. In FIG. 6A, the image display apparatus 10E, whose ID is E, is arranged at the right of the image display apparatus 10B. Even with this arrangement, the calculator 63 may calculate the arrangement status of the plurality of image display apparatuses 10 based on pieces of tag information received by for example the lower-right reader 15 and the upper-right reader 15 of the image display apparatus 10B. As a matter of course, the calculator 63 may calculate the arrangement status based on pieces of tag information received by the lower-left reader 15 and the upper-left reader 15 of the image display apparatus 10E.

In FIG. 6B, the image display apparatus 10E is arranged at the upper-right of the image display apparatus 10B. FIG. 6B shows an arrangement example in which only a vertex of the image display apparatus 10E is adjacent to a vertex of another image display apparatus, and sides of the image display apparatus 10E are not adjacent to sides of other image display apparatuses. Even in this case, the integration control apparatus 50 refers to a piece of tag information received by the upper-right reader 15 of the image display apparatus 10B or a piece of tag information received by the lower-left reader 15 of the image display apparatus 10E, whereby the calculator 63 is capable of calculating the arrangement status.

As described above, according to the image display system 100 of this embodiment, each corner 16 of each of the plurality of image display apparatuses 10 includes the tag 14 and the reader 15, which are capable of communicating with each other via near field communication. With this configuration, the reader 15 is capable of receiving data via near field communication from the tags 14 of the corners 16 of other image display apparatuses 10. As a result, it is possible to manage the arrangement status of the plurality of image display apparatuses 10 based on data received by the readers 15.

In this embodiment, the tag 14 and the reader 15 are capable of communicating with each other via near field communication in the area including the vicinal corners 18. The reader 15 receives pieces of tag information from the tags 14 of the vicinal corners 18 in the vicinity of the corner 16 on which the reader 15 is arranged. The reader 15 sends the pieces of received tag information to the integration control apparatus 50.

The integration control apparatus 50 collects pieces of tag information received by the readers 15, and determines which image display apparatus 10 each vicinal corner 18 belongs to. Moreover, the integration control apparatus 50 determines the position of the corner 16 of an image display apparatus 10 that each vicinal corner 18, on which a tag 14 is arranged, corresponds to. In this manner, there is realized a useful system capable of calculating and managing the arrangement status of the plurality of image display apparatuses 10, which are two-dimensionally arranged.

In recent years, display apparatuses configured to display images are being upsized. However, it may be difficult to upsize display apparatuses dramatically in the future from the viewpoints of manufacturing costs, demands, installation difficulty, and the like. Meanwhile, the widths of bezels (frames) of display apparatuses are getting smaller. An environment, which facilitates realization of an image display system constructing one large screen display with a plurality of arrayed displays, is being developed. Such an image display system is sometimes referred to as a grid-type display. Each display is sometimes referred to as a grid.

If the number of displays is small, it is not very difficult to arrange displays in a predetermined positional relation. In other words, it is relatively easy for an operator to set up each display, a central controller, or the like individually depending on the positional relation of displays after the displays are arranged. However, the larger the number of two-dimensionally arranged displays, the larger the burden imposed on an operator.

For example according to the above-mentioned technology described in Japanese Patent Application Laid-open No. 2012-83403, it is supposed that unit monitors are connected with each other by using connector members such as mechanical switches or connectors. In other words, it is necessary to expose such connector members on the side surfaces of the unit monitors. The connector members may thus be worn out, and in addition product design and the like may be likely to be restricted. Moreover, it is necessary for each unit monitor to manage eight signal senders and signal receivers arranged at the top, bottom, right, and left. Moreover, the configurations of the connector members, the signal senders, and the signal receivers are complicated.

According to another technology, light-emitting portions and light-receiving portions having directionality are provided on side surfaces of unit monitors, and information on arrangement of unit monitors is determined based on light-receiving timing. However according to this technology, similar to the technology of Japanese Patent Application Laid-open No. 2012-83403, it is necessary to expose light-emitting portions and light-receiving portions on the side surfaces of unit monitors. As a result, light-emitting portions and light-receiving portions may be worn out, and design may be degraded. Moreover, it is necessary to manage eight light-emitting portions and light-receiving portions. The structures of the light-emitting portions and the light-receiving portions may be complicated.

To the contrary, according to the image display system 100 of this embodiment, the tag 14 and the reader 15 for near field communication are arranged on each of the four corners 16 of the frame 12 of each image display apparatus 10. Moreover, pieces of tag information obtained by the readers 15 are collected. As a result, the shape of the entire large screen display is calculated, and the positions of the image display apparatuses 10 are calculated.

In RFID contactless near field communication, it is not necessary to connect the image display apparatuses with each other 10 by using connector members such as connectors. Moreover, because the communication directionality is low, it is not necessary to arrange the tags 14 and the readers 15 on the side surfaces of the image display apparatuses 10. That is, it is not necessary to arrange and expose connector members and communication devices on the side surfaces of the image display apparatuses. As a result, it is possible to prevent problems, which result from the above-mentioned worn-out members, from occurring. Moreover, it is possible to increase the degree of freedom of product design.

Moreover, in this embodiment, the tag 14 reacts to the reader 15, and communication is then established. Because of this, it is not necessary for the sender-side image display apparatus 10 to supply power to its tags 14 and to control the tags 14. That is, burden imposed on the image display apparatus 10 is reduced. For example, only by managing four readers 15, the image display system 100 may be operated properly. Moreover, managing costs may be reduced.

Moreover, an RFID tag and a reader have relatively simple configurations, and are low in cost. As a result, the configuration of the image display apparatus 10 may not be complicated, and the cost of the image display apparatus 10 may be reduced.

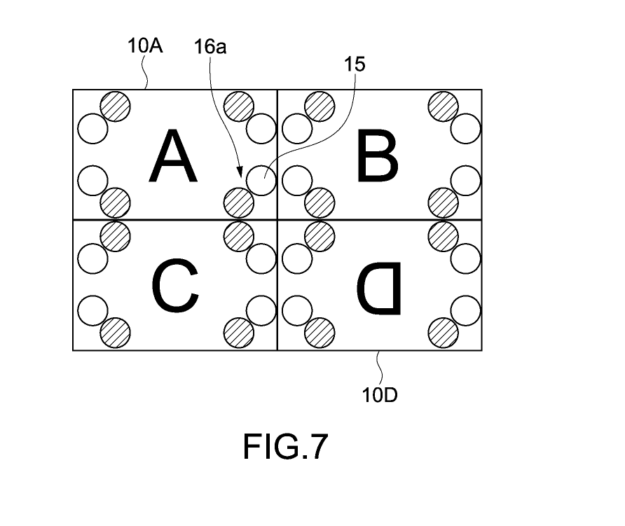

FIG. 7 is a diagram showing a state where an image display apparatus 10 is arranged upside down. In the example of FIG. 7, the image display apparatus 10D is arranged upside down. In this case, the reader 15 of the lower-right corner 16a of the image display apparatus 10A receives pieces of tag information (B, lower-left), (C, upper-right), and (D, lower-right).

In this embodiment, when the plurality of image display apparatuses 10 are two-dimensionally arranged, the tops come to the upper side, and the bottoms come to the lower side. Because of this, the reader 15 of the lower-right corner 16a of the image display apparatus 10A never receives tag information (D, lower-right) if the plurality of image display apparatuses 10 are arranged correctly. The detector 64 detects an error when such tag information is received. Moreover, the detector 64 detects the image display apparatus 10D, which is arranged upside down, based on the tag information resulting in an error.

The display unit 56 of the integration control apparatus 50 of FIG. 3 displays an alarm of the detected error, for example. Alternatively, the integration control apparatus 50 may notify an operator of the upside-down error with a sound and the like. As a result, an operator may detect erroneous arrangement, wrong arrangement, and the like promptly. It is possible to prevent proper image display from being prevented.

### Second Embodiment

An image display system according to a second embodiment of the present technology will be described. In the below description, configurations and effects similar to the configurations and effects of the image display system 100 of the above-mentioned embodiment will not be described, or description thereof will be simplified.

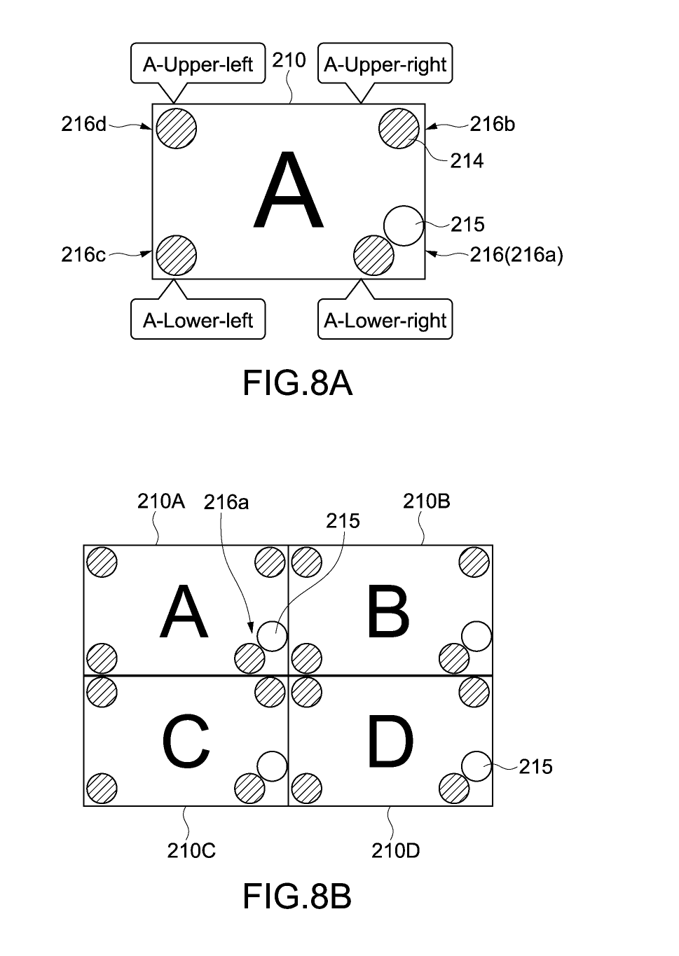

FIGS. 8A and 8B are diagrams each schematically showing image display apparatuses 210 of this embodiment. This embodiment is different from the first embodiment in the number of the reader 215 arranged on the image display apparatus 210. As shown in FIG. 8A, each of four corners 216 (plurality of adjacent portions) has a tag 214. In addition, a predetermined first corner of the four corners 216 has the reader 215. In other words, in this embodiment, the image display apparatus 210 has only one reader 215.

The position of the predetermined first corner out of the four corners 216 is determined. In other words, any one of lower-right, upper-right, lower-left, and upper-left corners 216 is set as a first corner. The set first corner of each image display apparatus 210 has the reader 215. As shown in FIGS. 8A and 8B, in this embodiment, the lower-right corner 216a is set as the first corner, and has the reader 215.

In this embodiment, the reader 215 of the lower-right corner 216a of the image display apparatus 210A obtains pieces of tag information. The pieces of tag information are referred to. Similar to the above-mentioned embodiment, the arrangement status is calculated as follows based on the pieces of tag information (B, lower-left), (C, upper-right), and (D, upper-left) obtained by the reader 215.

Tag information (B, lower-left): the image display apparatus 210B is arranged at the right of the image display apparatus 210A.

Tag information (C, upper-right): the image display apparatus 210C is arranged at the bottom of the image display apparatus 210A.

Tag information (D, upper-left): the image display apparatus 210D is arranged at the lower-right of the image display apparatus 210A.

The arrangement status is two-by-two (arrangement status of FIG. 8B), and the overall shape is rectangular.

If the tops of the image display apparatuses 210 come to the upper side and the bottoms come to the lower side as described above, and if the positions of the corners 216 having the readers 215 of the image display apparatuses 210 are the same (if each first corner has a reader), the number of the reader 215 arranged on the image display apparatus 210 may be only one.

The reader 215 (reader 215 of image display apparatus 10D) is capable of detecting no tags 214 arranged on the vicinal adjacent portions at a minimum. The reader 215 (reader 215 of image display apparatus 10A) is capable of detecting three tags 214 arranged on the vicinal adjacent portions at a maximum. Moreover, the reader 215 is capable of determining the positional relation of the adjacent image display apparatuses 210 based on pieces of tag information on the detected tags 214. Pieces of tag information obtained by the readers 215 of all the image display apparatuses 210 are collected, whereby it is possible to calculate the shape of the entire large screen display and the positions of the image display apparatuses 210. Because the number of the readers 215 is reduced, it is possible to reduce costs for components and management costs.

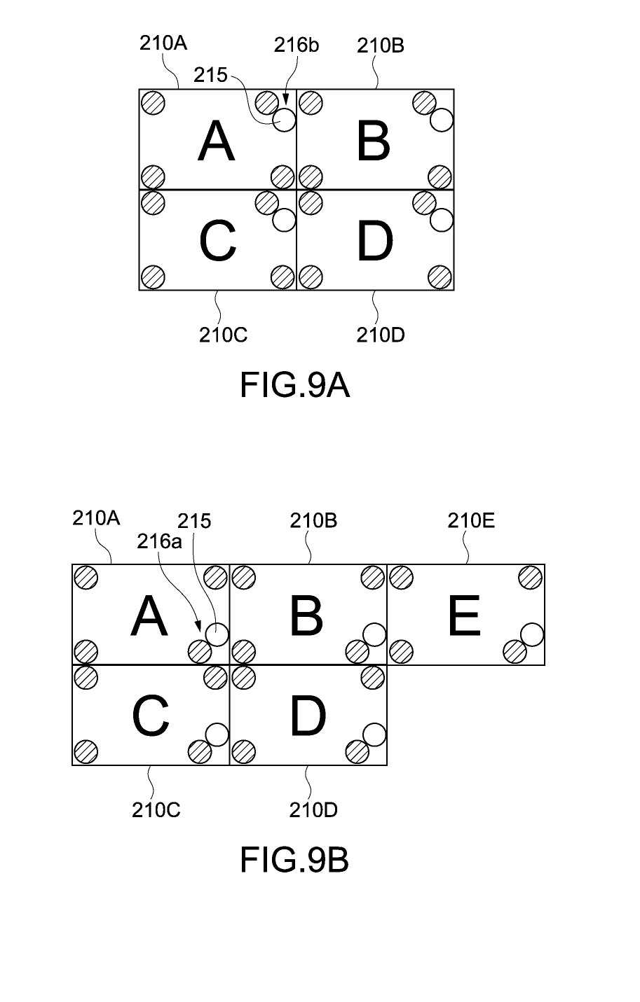

Each of FIGS. 9A and 9B to FIG. 11 is a diagram illustrating an arrangement example, in which each image display apparatus 210 includes one reader 215. The tops of the image display apparatuses 210 come to the upper side, and the bottoms come to the lower side. In this case, for example, a corner 216 other than the lower-right corner 216a may be set as a predetermined first corner. As shown in FIG. 9A, the upper-right corner 216b may be set as a first corner, and may have the reader 215.

For example, the reader 215 of the upper-right corner 216b of the image display apparatus 210C obtains pieces of tag information, and the arrangement status may be calculated based on the tag information. Alternatively, another corner 216 may be set as a first corner.

As shown in FIG. 9B, the overall shape of the plurality of two-dimensionally arranged image display apparatuses 210 may not be rectangular. For example if each lower-right corner 216a has the reader 215, and if the tops of the image display apparatuses 210 come to the upper side and the bottoms come to the lower side, an image display apparatus 210 may be arranged so that the image display apparatus 210 may be adjacent to any one of the image display apparatuses 210A to 210D of FIG. 8B. As shown in FIG. 9B, if the image display apparatus 210E is arranged at the right of the image display apparatus 210B, the reader 215 of the image display apparatus 210B receives tag information from the tag 214 of the image display apparatus 210E. The arrangement status may be calculated based on the tag information.

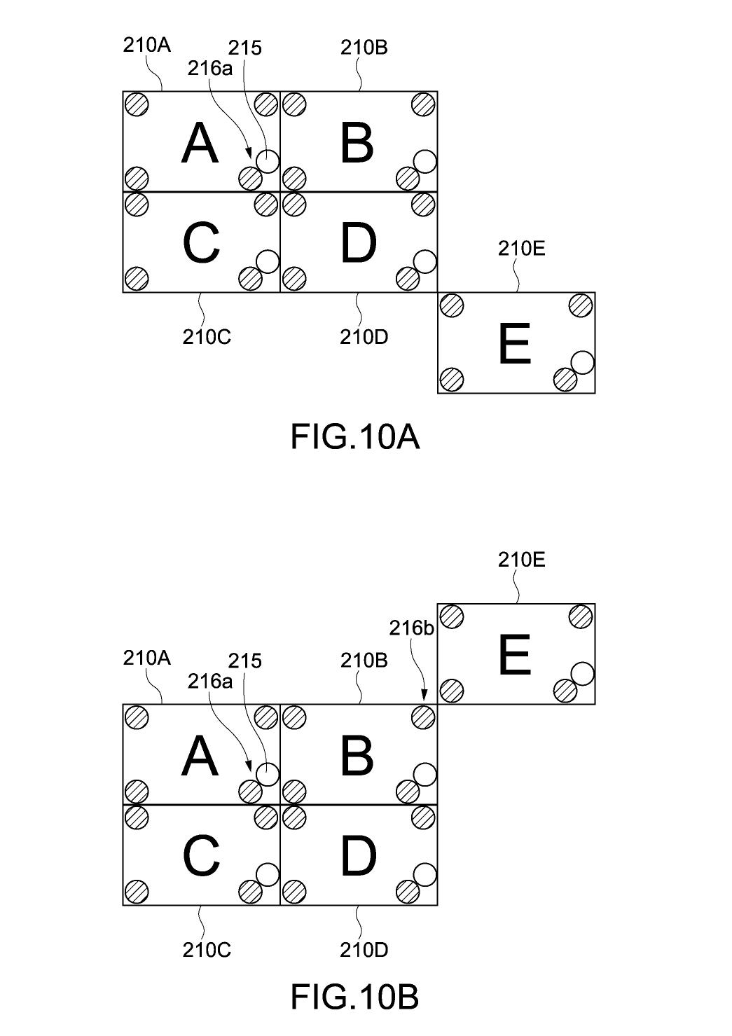

As shown in FIGS. 10A and 10B, only vertices may be adjacent to each other, and sides are not adjacent to each other. Note that, in this case, it is necessary to arrange another image display apparatus 210 so that the image display apparatus 210 may be adjacent to the lower-right corner 216a on which the reader 215 is arranged. In other words, a reader 215 of any one of the image display apparatuses 210 has to receive information on each image display apparatus 210.

In the example of FIG. 10A, the image display apparatus 210E is arranged at the lower-right of the image display apparatus 210D. In this case, the reader 215 of the image display apparatus 210D receives tag information from a tag 214 of the image display apparatus 210E. It is possible to calculate the arrangement status based on the tag information. Meanwhile, in the example of FIG. 10B, the image display apparatus 210E is arranged at the upper-right of the image display apparatus 210B. In this case, the image display apparatus 210E is adjacent to the corner 216b on which no reader 215 is arranged. With this structure, no reader 215 is capable of receiving tag information from the tags 214 of the image display apparatus 210E. In other words, according to the arrangement of FIG. 10B, it is not possible to calculate the arrangement status.

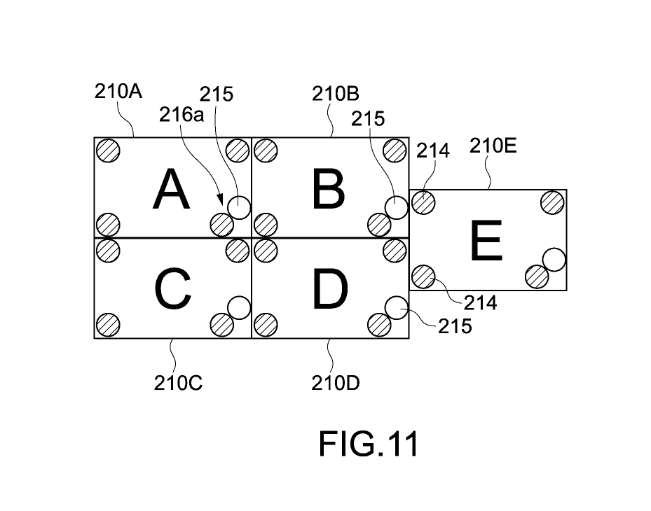

Moreover, the arrangement shown in FIG. 11 is different from the arrangement in which vertices are adjacent to each other. In this case, the arrangement status may not be calculated accurately. For example as shown in FIG. 11, the image display apparatus 210E is arranged at the right of the image display apparatuses 210B and 210D, and the boundary of the two image display apparatuses 210B and 210D is approximately at the center of one side of the image display apparatus 210E. In this case, neither the reader 215 of the image display apparatus 210B nor the reader 215 of the image display apparatus 210D receives tag information from the tags 214 of the image display apparatus 210E. Alternatively, the reader 215 of the image display apparatus 210B or the reader 215 of the image display apparatus 210D receives tag information on the image display apparatus 210E. In this case, also, it is only calculated that the image display apparatus 210E is arranged at the right of the image display apparatus 210B or 210D. The arrangement status is not calculated accurately.

In view of the examples of FIG. 10B and FIG. 11 and the like (i.e., in view of various conditions such as overall shape, arrangement, and direction, and other conditions), the number of the readers 215 arranged on the image display apparatus 210, the positions of the corners 216 on which the readers 215 are arranged, and the like may be set arbitrarily. Note that, in the example of FIG. 10B, tag information on the image display apparatus 210 (image display apparatus 210E of FIG. 10B) is not obtained out of the image display apparatuses 210 connecting to the integration control apparatus 50. In this case, for example an alarm may be displayed to inform of an error.

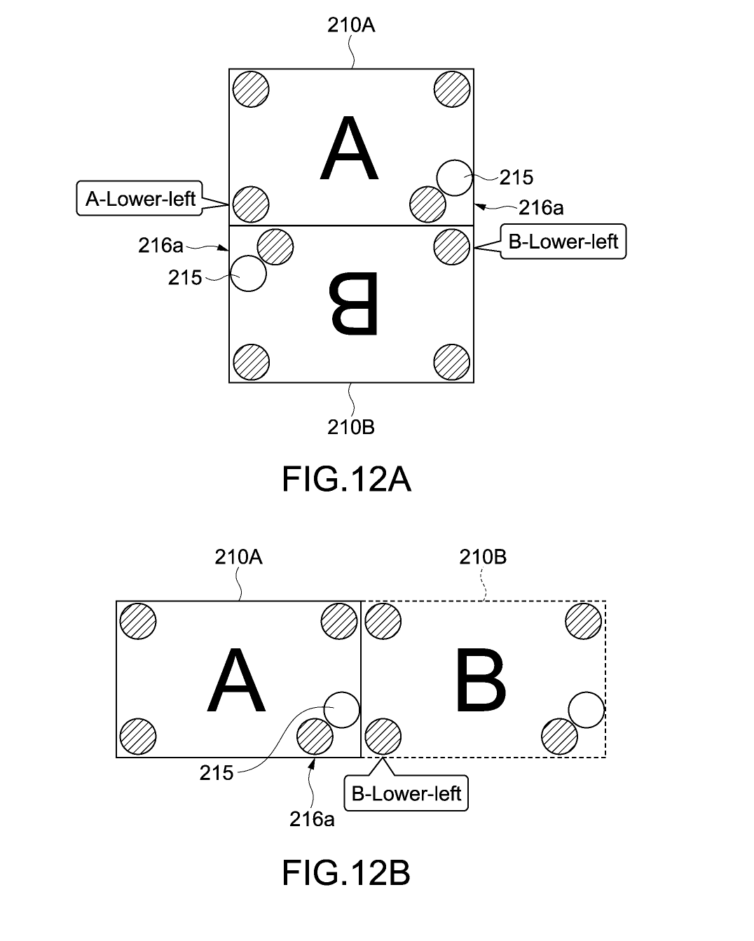

FIGS. 12A and 12B are diagrams showing a state where an image display apparatus 210 is arranged upside down. For example as shown in FIG. 12A, the image display apparatus 210B is below the image display apparatus 210A and is arranged upside down. Here, it is supposed that the tops of the image display apparatuses 210 come to the upper side, and the bottoms come to the lower side. Moreover, the reader 215 is arranged on the lower-right corner 216a, i.e., the first corner.

The reader 215 of the lower-right corner 216a of the image display apparatus 210A receives tag information (B, lower-left). It is calculated based on the information that the image display apparatus 210B is arranged at the right of the image display apparatus 210A as shown in FIG. 12B. In other words, it is calculated that the image display apparatus 210B is not arranged at the bottom and at the lower-right of the image display apparatus 210A. Meanwhile, the reader 215 of the lower-right corner 216 of the image display apparatus 210B receives tag information (A, lower-left). Based on the information, it is calculated that the image display apparatus 210A is arranged at the right of the image display apparatus 210B, and that the image display apparatus 210A is not arranged at the bottom and at the lower-right of the image display apparatus 210B.

In other words, there occurs conflict between an arrangement status based on one piece of tag information and an arrangement status based on the other piece of tag information. The detector 64 of the integration control apparatus 50 detects that such conflict (i.e., error) occurs. Then, the image display apparatus 210B arranged upside down is detected based on the tag information resulting in an error. An operator is notified of the detected error with alarm display, sounds, or the like. As a result, an operator is capable of detecting arrangement errors, wrong arrangement, and the like promptly. Note that an operator may be notified of an error, i.e., the upside-down image display apparatus 210A or 210B.

### Third Embodiment

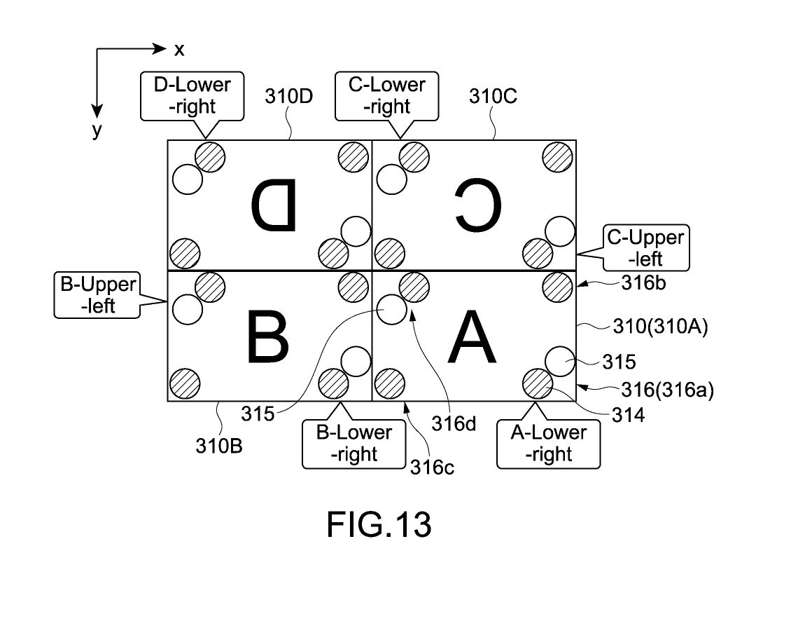

An image display system according to a third embodiment of the present technology will be described. FIG. 13 is a diagram schematically showing an arrangement status according to an example of this embodiment. The display unit of an image display apparatus 310 of this embodiment is a rectangle having a long-side direction and a short-side direction. Moreover, the display unit of the image display apparatus 310 is capable of being used right side up and upside down, the short-side direction being a vertical direction. In other words, the display unit of the image display apparatus 310 is capable of displaying an image properly even if it is upside down.

The vertical direction of the image display apparatus 310 has a normal-use orientation and an orientation opposite to the normal-use orientation. As a matter of convenience, the normal-use orientation will be referred to as “correct orientation”, and the orientation opposite to the normal-use orientation will be referred to as “inverse orientation”. In the example of FIG. 13, the image display apparatus 310B (correct orientation) is arranged at the left of the image display apparatus 310A (correct orientation). The image display apparatus 310C (inverse orientation) is arranged at the top of the image display apparatus 310A. The image display apparatus 310D (inverse orientation) is arranged at the top of the image display apparatus 310B, i.e., at the left of the image display apparatus 310C.

Tags 314 are arranged on four corners 316 of each image display apparatus 310. Readers 315 are arranged on a predetermined first corner and a second corner out of the four corners 316. The second corner is diagonal from the first corner. In other words, each image display apparatus 310 includes the four tags 314 and the two readers 315. As shown in FIG. 13, in this embodiment, the lower-right corner 316a is set as the first corner, and the upper-left corner 316d is set as the second corner. The readers 315 are arranged on the first and second corners, respectively.

In this embodiment, also, each reader 315 of each image display apparatus 310 obtains pieces of tag information. The pieces of tag information are combined. As a result, the arrangement status of the plurality of image display apparatuses 310 may be calculated.

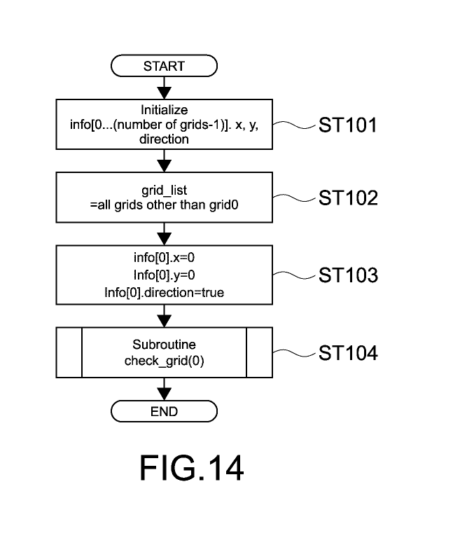

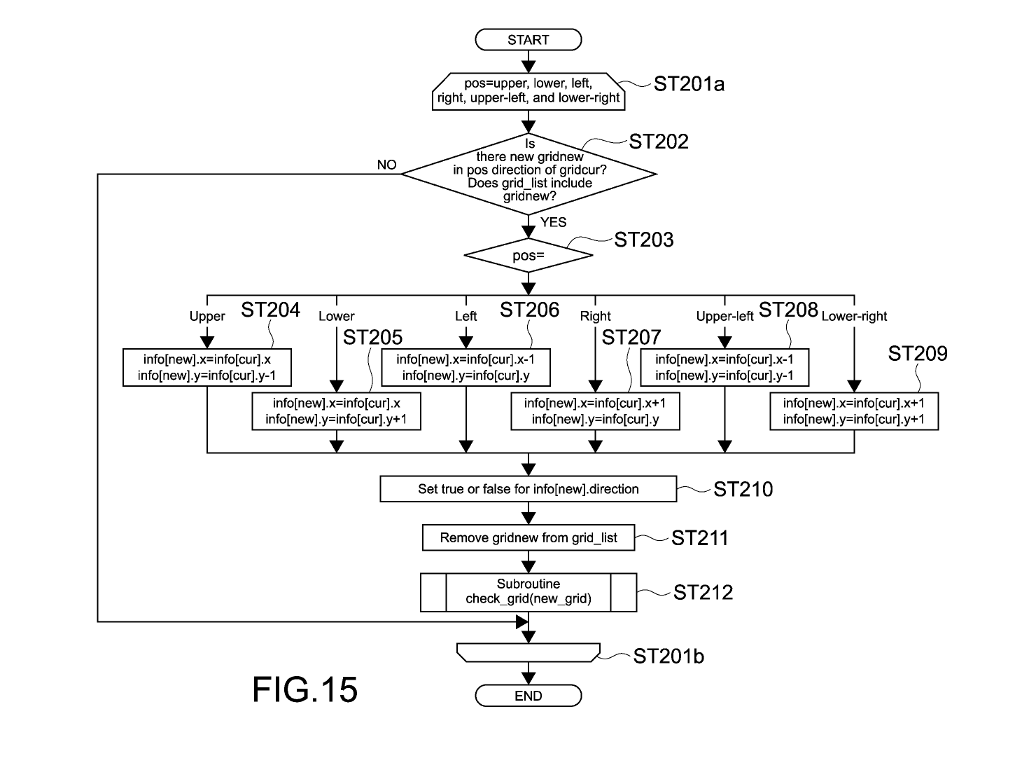

Each of FIG. 14 and FIG. 15 is a flowchart showing the flow of calculation of an arrangement status according to this embodiment. Hereinafter, the image display apparatus 310 will be referred to as a grid 310.

In this embodiment, the following pieces of information are stored corresponding to the plurality of arranged grids 310.

(info[0]. x, y, direction)

(info[1]. x, y, direction)

(info[2]. x, y, direction)
•
•
•

(info[n(n=grids−1)]. x, y, direction)

One piece of (info[ ]. x, y, direction) is stored for one grid 310.

The number in (info[ ]) is assigned to each grid 310. In this embodiment, the number 0 is assigned to the reference grid 310. The numbers 1 to n are assigned to the other grids 310. Any method of assigning numbers may be employed. For example the grid 310, which connects to the integration control apparatus 50 first, is selected as the grid 310 having the number 0. After that, sequence numbers are assigned in the order of connection. Such a method may be used. Another arbitrary method may be used.

Hereinafter, a grid to which a number is assigned will be referred to as “grid(number)”. For example, the grid 310 to which the number 0 is assigned is “grid0”.

(info[ ]. x, y) means a relative position from the grid 310 having the number 0. In this embodiment, as shown in FIG. 13, a coordinate system is set to show the positions of the two-dimensionally arranged grids 310. The coordinate of the grid0, i.e., the origin, is (0, 0).

If a grid is adjacent to the grid0 in the positive direction of a coordinate axis, the coordinate value is larger than that of the grid0 by one. If a grid is adjacent to the grid0 in the negative direction of a coordinate axis, the coordinate value is smaller than that of the grid0 by one. In other words, grid0 has (info[0]. 0, 0). The grid 310 at the right of the grid0 has (info[ ]. 1, 0). Moreover, the grid at the lower-left of the grid0 is (info[ ]. −1, 1).

(info[ ].direction) shows the vertical orientation of each grid 310. In other words, (info[ ].direction) is information concerning if the grid 310 is arranged in the correct orientation or in the inverse orientation. In this case, also, the grid 310 having number 0 is the reference. If the orientation of a grid 310 is same as the orientation of the grid0, the grid 310 has (info[ ].true). Meanwhile, if the orientation of a grid 310 is opposite to the orientation of the grid0, the grid 310 has (info[ ].false).

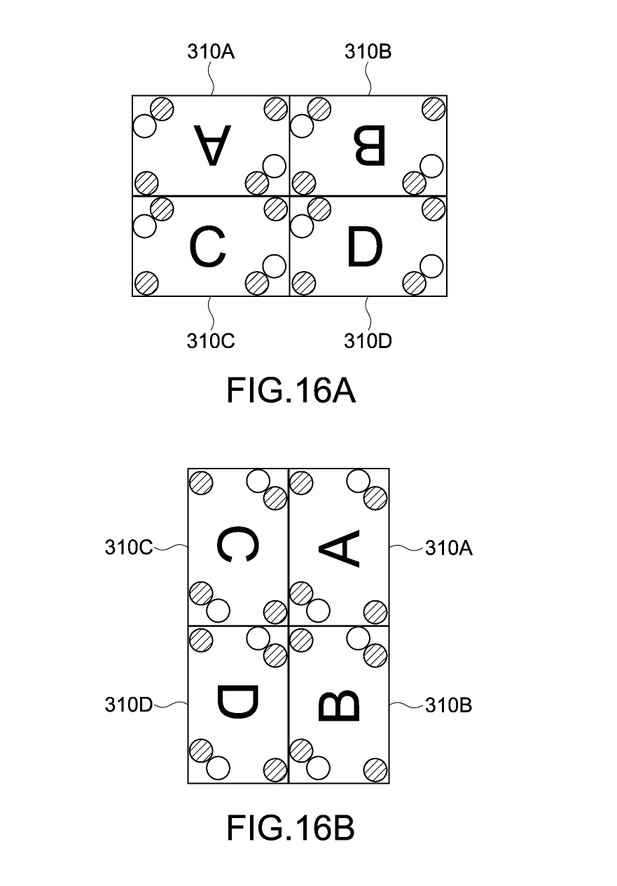

The vertical orientation of the grid 310 is used to display an image properly. Meanwhile, the orientation of the entire two-dimensionally arranged grids 310 is different depending on a use situation. For example as shown in FIG. 16A, in some cases, when the plurality of grids 310 are used, the positional relation of the plurality of grids 310 is the same as the positional relation of FIG. 13, and the entire grids 310 are rotated by 180 degrees. Moreover, as shown in FIG. 16B, in some cases, when the plurality of grids 310 are used, the positional relation of the plurality of grids 310 is the same as the above, and the entire grids 310 are rotated by 90 degrees. In this manner, in some cases, the orientation of the entire grids 310 is set arbitrarily, and the grids 310 are used.

In the example of FIG. 16A, when the grids 310 are arranged, the entire grids 310 are downward-facing, and the downward-facing orientation is the correct orientation. In the example of FIG. 16B, when the grids 310 are arranged, the entire grids 310 are laterally-facing, and the laterally-facing orientation is the correct orientation. The above-mentioned (info[ ].direction) is information concerning the orientation of each grid 310 out of the plurality of grids 310, irrespective of the orientation of the entire grids 310.

With this configuration, according to calculation of an arrangement status of this embodiment, the positional relation of each grid 310 may be determined uniquely, but the entire orientation may not be determined. To deal with this matter, a sensor configured to detect an orientation may be used, or an operator may confirm with his eyes and set the orientation. The latter method to deal with this matter troubles the operator. However, all he needs is to set up the entire system only once. So a burden imposed on him is lower enough than a burden when setting positions of grids, which leads to a problem.

(info[ ]. x, y, direction) of all the grids 310 are calculated, and the arrangement status is thus calculated. Hereinafter, description will be made in more detail.

With reference to the flowchart of FIG. 14, first, (info[ ]. x, y, direction) corresponding to each grid 310 is initialized (Step 101).

grid1 to gridn other than grid0 (origin) are set for grid_list (Step 102). grid_list is a list in which the grids 310, whose positions and orientations are unknown, are set. If no grid 310 is set for grid_list, the arrangement status is calculated.

Information on grid0 is set for (info[ ]. 0, 0, true) (Step 103). A subroutine check_grid(cur) is read out, and the subroutine check_grid(0) is executed in which grid0 is the origin (Step 104).

FIG. 15 is a flowchart showing the flow of check_grid(cur). As shown in Steps 201a and 201b, loop processing is executed for upper, lower, left, right, upper-left, and lower-right positions. The upper, lower, left, right, upper-left, and lower-right positions are adjacent positions in the respective directions. In other words, a grid 310, which is adjacent to the passed grid(gridcur), is inspected in order. Here, the grid 310 adjacent to grid0 is inspected.

It is determined if there is a new grid 310 (gridnew) in the pos direction (above-mentioned position direction) of gridcur or not. In addition, it is determined if grid_list includes gridnew or not (Step 202). Here, first, it is determined if there is a grid 310 adjacent to the upper side of grid0 or not. In addition, it is determined if grid_list includes the grid 310 or not. Note that if there is gridnew in the pos direction or not is determined based on pieces of tag information collected by the integration control apparatus 50.

If there is no gridnew or if inspection is completed and grid_list includes no gridnew (Step 202, No), the next position is inspected (Step 201b).

If there is gridnew (Step 202, Yes), the position of gridnew is set up based on the position of gridcur and the position of gridnew. In other words, after Step 203, (info[new]. x, y) is set up as follows based on the coordinate system of FIG. 13.

If pos=upper (Step 204),

info[new].x=info[cur].x

info[new].y=info[cur].y−1

If pos=lower (Step 205),

info[new].x=info[cur].x

info[new].y=info[cur].y+1

If pos=left (Step 206),

info[new].x=info[cur].x−1

info[new].y=info[cur].y

If pos=right (Step 207),

info[new].x=info[cur].x+1

info[new].y=info[cur].y

If pos=lower-left (Step 208),

info[new].x=info[cur].x−1

info[new].y=info[cur].y−1

If pos=lower-right (Step 209),

info[new].x=info[cur].x+1

info[new].y=info[cur].y+1

For example let's assume that there is grid1 (gridnew) at the upper side of grid0. Then the position information on grid1 is (info[1]. 0, −1). For example if there is grid1 at the lower-right side of grid0, the position information is (info[1]. 1, 1). In this manner, position information on an adjacent grid is calculated.

With reference to the orientation of grid0, the orientation of gridnew is determined, and true or false is set for (info[new].direction) (Step 210). Since the position and the orientation of gridnew are clarified, gridnew is removed from grid_list (Step 211).

The subroutine check_grid(cur) is recursively read out, and the subroutine check_grid (new_grid) is executed, in which a gridnew is the origin (Step 212). In other words, the gridnew is inspected. If the recursively read-out subroutine check_grid(new_grid) is completed, then it is inspected if there is a grid or not at the next position. If the grids at all the positions are inspected, and if all (info[ ]. x, y, direction) are calculated, the arrangement status is calculated.

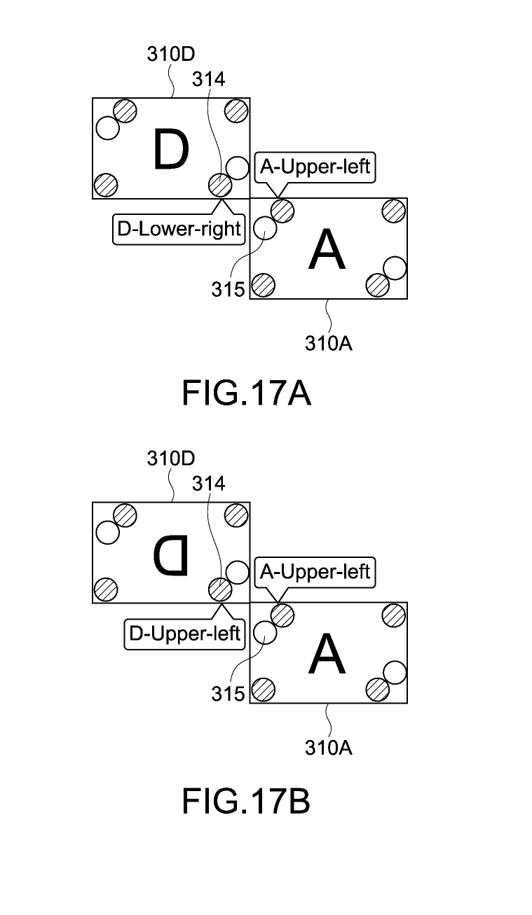

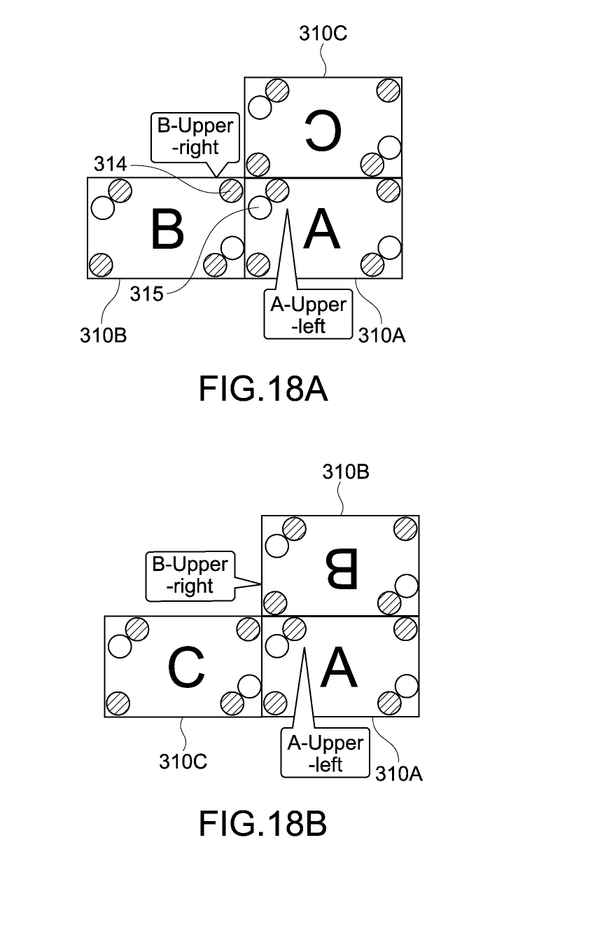

Here, an example of a method of determining an adjacent grid and the orientation of the adjacent grid based on pieces of tag information collected by the integration control apparatus 50 will be described. FIGS. 17A and 17B and FIGS. 18A and 18B are diagrams schematically illustrating the method.

Method of confirming grid (pos=upper-left). In the arrangement of FIG. 17A, the upper-left reader 315 of the grid 310A reads tag information from the lower-right tag 314 of the grid 310D. Alternatively, in the arrangement of FIG. 17B, the upper-left reader 315 of the grid 310A reads tag information from the upper-left tag 314 of the grid 310D. In the arrangements of FIGS. 17A and 17B, there is no grid 310 at the upper or left side of the grid 310A. However, even if there are, the upper-left reader 315 of the grid 310A reads no tag information on the lower-right or upper-left tag 314 of the grid 310 at the upper or left side of the grid 310A, from the viewpoint of the positional relation.

Because of this, once the upper-left or lower-right tags 314 are read, it is determined that there is a grid at the upper-left of the grid 310A. At this time, as shown in FIG. 17A, if the lower-right tag 314 of the grid 310D is read, then the orientation of the grid 310D is the correct orientation (direction=true). As shown in FIG. 17B, if the upper-left tags 314 of the grid 310D is read, the orientation of the grid 310D is the inverse orientation (direction=false). The grid (pos=lower-right) may be confirmed similarly.

Method of confirming grid (pos=left). In the arrangement of FIG. 18A, the upper-left reader 315 of the grid 310A reads tag information from the upper-right tag 314 of the grid 310B. Meanwhile, also in the arrangement of FIG. 18B, the upper-left reader 315 of the grid 310A reads tag information from the upper-right tag 314 of the grid 310B. Because of this, the position (left or upper side of grid 310A) of the grid 310B may not be determined only by reading the upper-right tag 314 of the grid 310B.

At this time, if a reader 315 of the grid 310B reads the lower-left tag 314 of the grid 310A, it is determined that the arrangement of FIG. 18A is established. Moreover, it may be determined that the orientation of the grid 310B is the correct orientation (direction=true). If a reader 315 of the grid 310B reads the upper-right tag 314 of the grid 310A, it is determined that the arrangement of FIG. 18B is established. In this case, the orientation of the grid 310B is the inverse orientation (direction=false). The grids (pos=upper, right, left) may be confirmed similarly.

As described above, according to this embodiment, even if the orientation of the image display apparatuses 310 is not strictly limited, it is possible to calculate an arrangement status of the plurality of image display apparatuses 310 by combining pieces of tag information from the tags 314.

### Fourth Embodiment

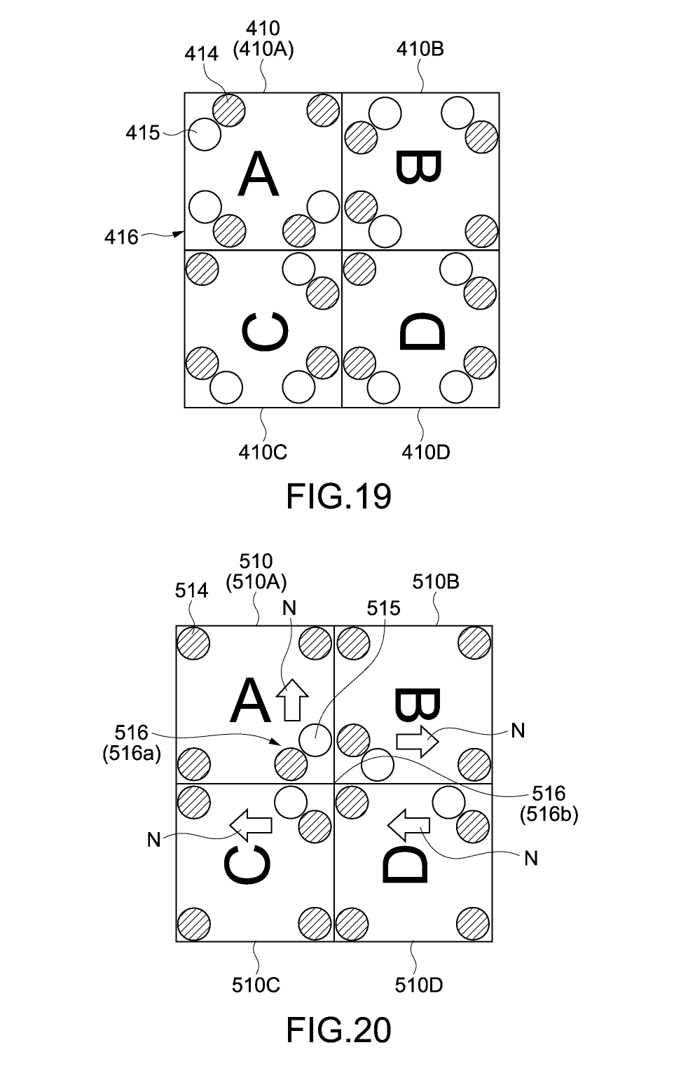

FIG. 19 is a diagram schematically showing an arrangement status according to an example of a fourth embodiment of the present technology. In this embodiment, each image display apparatus 410 has a square display unit with equal sides, and the image display apparatuses 410 are arranged two-dimensionally. Moreover, the image display apparatuses 410 may be used in the both vertical orientations and in the both horizontal orientations. In other words, the display unit is capable of displaying an image properly even upside down. The display unit is capable of displaying an image properly even if the display unit is rotated by 90 degrees. In other words, the display unit is capable of displaying an image properly irrespective of a side at the bottom out of the four sides.

As shown in FIG. 19, the tags 414 are arranged on the four corners 416 of each image display apparatus 410, respectively. The readers 415 are arranged on predetermined three corners out of the four corners 416. In other words, each image display apparatus 410 has the four tags 414 and the three readers 415. In the above-mentioned third embodiment, two readers are arranged. However, in this embodiment, it is necessary to determine not only vertical orientation but also horizontal orientation. So the three readers 415 are arranged. The tags 414 and the readers 415 are used, and for example the calculation process described in the third embodiment is used, whereby it is possible to calculate the arrangement status of FIG. 19.

Note that in the present disclosure, “a rectangle” (or “rectangular”) means a tetragon having the four equal angles, and conceptually includes a rectangle having long sides and short sides and a square having equal sides.

### Fifth Embodiment

FIG. 20 is a diagram schematically showing an arrangement status according to an example of a fifth embodiment of the present technology. Similar to the fourth embodiment, each image display apparatus 510 of this embodiment is a square and may be used in the both vertical orientations and in the both horizontal orientations.

Moreover, the image display apparatus 510 of this embodiment includes a sensor (detector) (not shown) capable of detecting the arrangement direction when the image display apparatuses 510 are arranged two-dimensionally. As the sensor, for example an angular velocity sensor such as a gyro sensor, an acceleration sensor, or the like is used. Alternatively, an arbitrary sensor capable of detecting orientation may be used.

As shown in FIG. 20, the tags 514 are arranged on the four corners 516 of each image display apparatus 510. The reader 515 is arranged on a predetermined first corner out of the four corners 516. In this embodiment, the lower-right corner 516a is set as the first corner, and the reader 515 is arranged on the lower-right corner 516a. Moreover, the sensor detects which orientation (upper, lower, left, or right) the vertical correct orientation (arrow N) is oriented.

Pieces of tag information obtained by each reader 515 are sent to the integration control apparatus. Moreover, orientation information on each image display apparatus detected by its sensor is sent. Those pieces of information are combined, whereby the arrangement status of FIG. 20 (overall shape is rectangular) is calculated.

For example the lower-right reader 515 of the image display apparatus 510A receives pieces of tag information (B, lower-right), (C, lower-right), and (D, upper-right). The pieces of tag information (B, lower-right), (C, lower-right), and (D, upper-right) are sent to the integration control apparatus. Moreover, orientation information is referred to as (ID, orientation). Each sensor sends information on (A, upper orientation), (B, right orientation), (C, left orientation), or (D, left orientation) to the integration control apparatus.

The integration control apparatus recognizes that the lower-right corner 516a of the image display apparatus 510A is at the lower-right position in fact. Moreover, the integration control apparatus recognizes that the lower-right corner 516b of the image display apparatus 510B (right orientation) is at the lower-left position in fact. In view of this, it is determined that the lower-right reader 515 of the image display apparatus 510A reads the lower-right tag 514 of the image display apparatus 510B. As a result, it is calculated that the image display apparatus 510B (left orientation) is adjacent to the right of the image display apparatus 510A (upper orientation). The arrangement statuses of the image display apparatuses 510C and 510D may be calculated in the same manner.

As described above, in this embodiment, each image display apparatus 510 includes a sensor capable of detecting the arrangement direction. With this configuration, even if the number of the readers is smaller, it is possible to calculate the arrangement status irrespective of upper, lower, left, or right orientation. Moreover, it is possible to easily determine the orientation of the plurality of arranged image display apparatuses 510 as a whole. As a matter of course, in the other embodiments, a sensor capable of detecting the arrangement direction may be employed. For example, the image display apparatus 310 of the third embodiment includes a sensor. With this configuration, it is possible to distinguish and calculate the arrangement statuses having different orientations as a whole as shown in FIGS. 16A and 16B and the like. As a result, it is possible to reduce a burden imposed on an operator.

### Sixth Embodiment

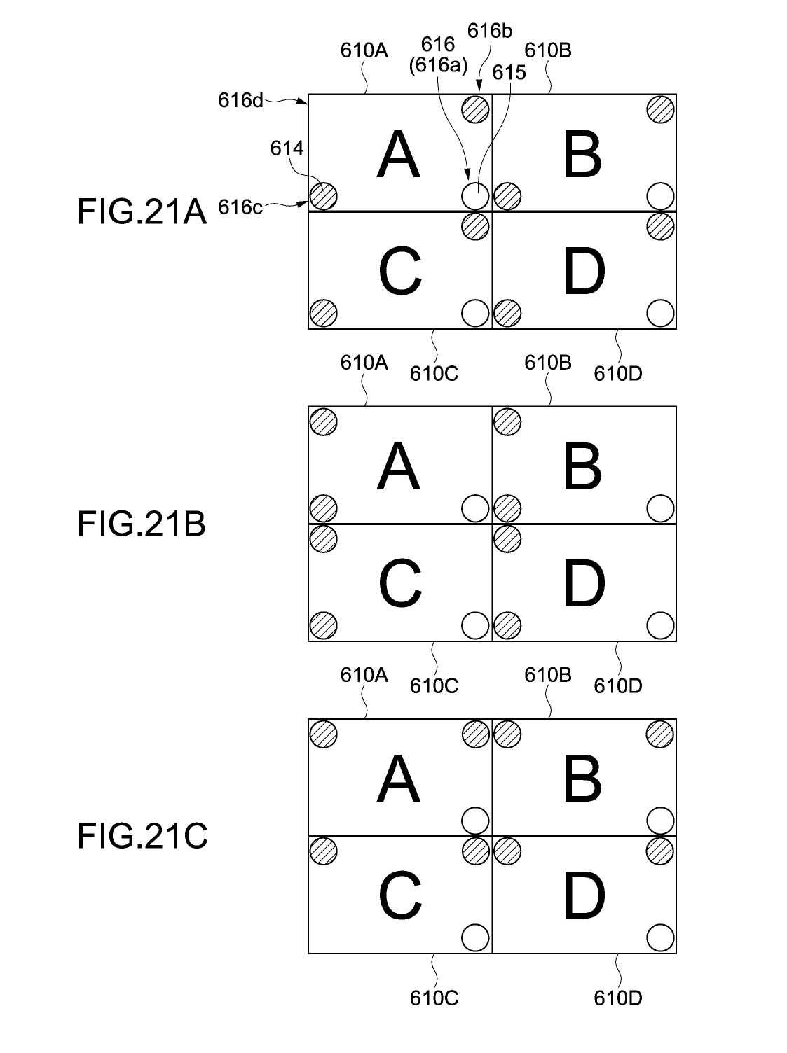

Each of FIGS. 21A, 21B, and 21C is a diagram schematically showing an arrangement status according to an example of a sixth embodiment of the present technology. This embodiment is different from the above-mentioned embodiments in the number of tags arranged on each image display apparatus. As shown in FIGS. 21A, 21B, and 21C, each image display apparatus 610 is rectangular, and has its top and bottom in use. In other words, if the image display apparatuses 610 are arranged two-dimensionally, the tops of the image display apparatuses 610 come to the upper side, and the bottoms come to the lower side.

The reader 615 is arranged on the lower-right corner 616a, which is set as a predetermined first corner, out of the four corners 616. The tags 614s are arranged on two corners 616 out of the three corners 616 except the lower-right corner 616, i.e., the first corner, out of the four corners. In other words, the tags 614 are arranged on two of the three corners, i.e., the upper-right, lower-left, and upper-left corners 616b to 616d. As shown in FIG. 21A, the tags 614 may be arranged on the upper-right and lower-left corners 616b and 616c. Alternatively, as shown in FIG. 21B, the tags 614 may be arranged on the lower-left and upper-left corners 616c and 616d. Alternatively, as shown in FIG. 21C, the tags 614 may be arranged on the upper-right and upper-left corners 616b and 616d.

For example, in the example of FIG. 21A, the lower-right reader 615 of the image display apparatus 610A obtains pieces of tag information (B, lower-left) and (C, upper-right). It is possible to calculate based on those pieces of tag information that the image display apparatus 610B is at the right of the image display apparatus 610A, and that the image display apparatus 610C is at the bottom of the image display apparatus 610A. Moreover, the lower-right reader 615 of the image display apparatus 610B obtains a piece of tag information (D, upper-right). It is possible to calculate that the image display apparatus 610D is at the bottom of the image display apparatus 610B based on the tag information. As a result, it is possible to calculate the arrangement status of FIG. 21A.

In the example of FIG. 21B, the lower-right reader 615 of the image display apparatus 610A obtains pieces of tag information (B, lower-left) and (D, upper-left). It is possible to calculate based on those pieces of tag information that the image display apparatus 610B is at the right of the image display apparatus 610A, and that the image display apparatus 610D is at the lower-right of the image display apparatus 610A. Moreover, the lower-right reader 615 of the image display apparatus 610C obtains a piece of tag information (D, lower-left). It is possible to calculate based on the tag information that the image display apparatus 610D is at the right of the image display apparatus 610C, i.e., that the image display apparatus 610C is at the left of the image display apparatus 610D. As a result, it is possible to calculate the arrangement status of FIG. 21B.

In the example of FIG. 21C, the lower-right reader 615 of the image display apparatus 610A obtains pieces of tag information (C, upper-right) and (D, upper-left). It is possible to calculate based on those pieces of tag information that the image display apparatus 610C is at the bottom of the image display apparatus 610A, and that the image display apparatus 610D is at the lower-right of the image display apparatus 610A. Moreover, the lower-right reader 615 of the image display apparatus 610B obtains a piece of tag information (D, upper-right). It is possible to calculate based on the tag information that the image display apparatus 610D is at the bottom of the image display apparatus 610B, i.e., the image display apparatus 610B is at the top of the image display apparatus 610D. As a result, it is possible to calculate the arrangement status of FIG. 21C.

As described above, even if each image display apparatus 610 includes only two tags 614, it is possible to calculate the overall shape of the plurality of two-dimensionally arranged image display apparatuses 610 and the positions of the image display apparatuses 610. In view of various conditions such as overall shape, arrangement, and direction, and other conditions, the number of the readers 615 arranged on the image display apparatus 610 may be set arbitrarily.

### Other Embodiments

The present technology is not limited to the above-mentioned embodiments, and other various embodiments may be realized.

As senders and receivers arranged on image display apparatuses, devices or mechanisms different from RFID tags and RFID readers may be provided. Any arbitrary device or mechanism may be used as long as it is possible to establish communication only within a predetermined distance. A communication medium is not limited to a radio wave or the like, but may be light, magnetism, or the like.

Moreover, instead of a communication device communicable within a predetermined distance, a communication device capable of establishing communication within a larger communicable area may be used. Even in this case, it is possible to execute the above-mentioned process of calculating an arrangement status as long as a receiver is capable of determining the physical distance from a sender of another unit apparatus to some extent and determining if the sender is close to the receiver or not. In other words, even if a receiver is capable of communicating with senders even arranged on adjacent portions other than its vicinal adjacent portions, it is possible to calculate the arrangement status based on data from the senders as long as the receiver is capable of determining if each sender is on a vicinal adjacent portion or a distant position.

The integration control apparatus may arbitrarily control, based on the calculated arrangement status, delivery targets of divided images obtained by dividing an image (content) to be displayed, the display orientation, the size of each divided image, and the like.

The delivery targets are two-dimensionally arranged image display apparatuses. When displaying the content, the arrangement status of a plurality of two-dimensionally arranged image display apparatuses may be changed in an intended manner. In other words, the position and the orientation of each image display apparatus may be changed. Alternatively, the number of image display apparatuses in use may be changed. As a result, it is possible to improve the design greatly, and offer entertainment. According to the present technology, it is possible to calculate a new arrangement status depending on change of an arrangement status. As a result, it is possible to arbitrarily change delivery targets of divided images, the orientation, the size of each divided image, and the like. As a result, it is possible to display content properly and to use a system properly.

In the above-mentioned embodiments, a plurality of image display apparatuses are arranged two-dimensionally, and an image display system is thus constructed. Alternatively, the present technology is applicable to a case where information processing apparatuses other than image display apparatuses are arranged. In other words, the kind of unit apparatuses to be arranged is not limited. For example, a plurality of input apparatuses, each of which receives operations input by a user, may be arrayed as unit apparatuses. For example, a plurality of touchpads are two-dimensionally arrayed, and are used as one large touchpad, i.e., a so-called grid-type touchpad. The present technology is applicable to such a grid-type touchpad. Alternatively, a plurality of unit apparatuses may be various inspection apparatuses or the like.

Note that the effects described in the present disclosure are merely examples and are not specifically limited. Moreover, other effects may be obtained. The above-mentioned plurality of effects may be or may not be obtained simultaneously. At least one of the above-mentioned plurality of effects may be obtained depending on conditions or the like. As a matter of course, effects not described in the present disclosure may be obtained.

At least two characteristics of the above-mentioned embodiments may be combined. In other words, the characteristics of the above-mentioned embodiments may be combined arbitrarily without distinguishing the embodiments.

Note that the present technology may employ the following configurations:

(1) An image display apparatus, comprising:

a display unit capable of displaying an image;

a plurality of adjacent portions arranged on the display unit at a predetermined positional relation;

senders capable of sending data via near field communication, the senders being arranged on at least two of the plurality of adjacent portions, respectively; and

a receiver capable of receiving data via the near field communication from a sender of another image display apparatus, the receiver being arranged on at least one of the plurality of adjacent portions.

(2) The image display apparatus according to the item (1), wherein

each of the senders is capable of sending the data within an area including a vicinal adjacent portion, the vicinal adjacent portion being an adjacent portion in the vicinity of the sender out of a plurality of adjacent portions of the other image display apparatus, and

the receiver is capable of receiving data from the sender of the other image display apparatus within the area including the vicinal adjacent portion, the sender being arranged on the vicinal adjacent portion.

(3) The image display apparatus according to the item (1) or (2), wherein

the display unit is a polygon, and

each of the plurality of adjacent portions is a vertex portion of the polygon.

(4) The image display apparatus according to any one of the items (1) to (3), wherein

the display unit is a rectangle,

the senders are arranged on four corners, the four corners being the plurality of adjacent portions, and

the receiver is arranged on at least a predetermined first corner out of the four corners.

(5) The image display apparatus according to the item (4), wherein

the receiver is at least arranged on each of the first corner and a second corner out of the four corners, the second corner being diagonal from the first corner.

(6) The image display apparatus according to the item (4) or (5), wherein

the receiver is arranged on each of the four corners.

(7) The image display apparatus according to any one of the items (1) to (3), wherein

the display unit is a rectangle,

the receiver is at least arranged on a predetermined first corner out of four corners, the four corners being the plurality of adjacent portions, and

the senders are arranged on two corners out of three corners excluding the first corner out of the four corners.

(8) The image display apparatus according to any one of the items (1) to (7), wherein

the display unit has its top and bottom in use, and

the tops of the display units of the image display apparatus and the other image display apparatus come to the upper side, and the bottoms come to the lower side.

(9) The image display apparatus according to the item (5), wherein

the display unit has a long-side direction and a short-side direction, the display unit being capable of being used right side up and upside down, the short-side direction being a vertical direction, and

the receiver is arranged on each of the first and second corners.

(10) The image display apparatus according to any one of the items (1) to (9), further comprising:

a detector capable detecting an arrangement direction.

(11) The image display apparatus according to any one of the items (1) to (10), wherein

the senders are RFID (Radio Frequency IDentification) tags, and

the receiver is an RFID reader.

(12) An information processing apparatus capable of controlling at least part of operations of a plurality of unit apparatuses,

each of the plurality of unit apparatuses including
a plurality of adjacent portions having a predetermined positional relation,
senders capable of sending data via near field communication, the senders being arranged on at least two of the plurality of adjacent portions, respectively, and
a receiver capable of receiving data via the near field communication from a sender of another unit apparatus, the receiver being arranged on at least one of the plurality of adjacent portions,

the information processing apparatus comprising:

a data receiver configured to receive the data, the receiver of each of the plurality of unit apparatuses receiving the data from the sender via the near field communication; and

a calculator capable of calculating an arrangement status of the plurality of unit apparatuses based on the received data.

(13) The information processing apparatus according to the item (12), wherein

each of the senders of each of the plurality of unit apparatuses is capable of sending the data via the near field communication within an area including a vicinal adjacent portion, the vicinal adjacent portion being an adjacent portion in the vicinity of the sender out of a plurality of adjacent portions of the other unit apparatus,

the receiver of each of the plurality of unit apparatuses is capable of receiving data from the sender of the other unit apparatus via the near field communication within the area including the vicinal adjacent portion, the sender being arranged on the vicinal adjacent portion,

the information processing apparatus further comprises a determining unit capable of
determining the other unit apparatus including the vicinal adjacent portion on which the sender is arranged based on the data received by the data receiver, the vicinal adjacent portion being in the vicinity of the adjacent portion on which the receiver is arranged, and
determining a position of the vicinal adjacent portion on which the sender is arranged out of the plurality of adjacent portions of the other unit apparatus, and

the calculator is capable of calculating an arrangement status of the plurality of unit apparatuses based on a determination result of the other unit apparatus including the vicinal adjacent portion determined by the determining unit, and based on a determination result of the position of the vicinal adjacent portion determined by the determining unit.

(14) The information processing apparatus according to the item (13), wherein

each of the plurality of unit apparatuses has its top and bottom in use,

the tops of the plurality of unit apparatuses come to the upper side, and the bottoms come to the lower side, and

the information processing apparatus further comprises a detector capable of detecting an upside-down unit apparatus out of the plurality of unit apparatuses based on the determination result determined by the determining unit.

(15) The information processing apparatus according to any one of the items (12) to (14), wherein

each of the plurality of unit apparatuses includes a detector capable detecting an arrangement direction, and

the calculator is capable of calculating an arrangement status of the plurality of unit apparatuses based on the arrangement direction of each of the plurality of unit apparatuses detected by the detector.

It should be understood by those skilled in the art that various modifications, combinations, sub-combinations and alterations may occur depending on design requirements and other factors insofar as they are within the scope of the appended claims or the equivalents thereof.

What is claimed is:

1. An image display apparatus, comprising:
a display unit capable of displaying an image;
a plurality of adjacent portions arranged on the display unit at a predetermined positional relation;
senders capable of sending data via near field communication, the senders being arranged on at least two of the plurality of adjacent portions, respectively; and
a receiver capable of receiving data via the near field communication from a sender of another image display apparatus, the receiver being arranged on at least one of the plurality of adjacent portions.

2. The image display apparatus according to claim 1, wherein
each of the senders is capable of sending the data within an area including a vicinal adjacent portion, the vicinal adjacent portion being an adjacent portion in the vicinity of the sender out of a plurality of adjacent portions of the other image display apparatus, and
the receiver is capable of receiving data from the sender of the other image display apparatus within the area including the vicinal adjacent portion, the sender being arranged on the vicinal adjacent portion.

3. The image display apparatus according to claim 1, wherein
the display unit is a polygon, and
each of the plurality of adjacent portions is a vertex portion of the polygon.

4. The image display apparatus according to claim 1, wherein
the display unit is a rectangle,
the senders are arranged on four corners, the four corners being the plurality of adjacent portions, and
the receiver is arranged on at least a predetermined first corner out of the four corners.

5. The image display apparatus according to claim 4, wherein
the receiver is at least arranged on each of the first corner and a second corner out of the four corners, the second corner being diagonal from the first corner.

6. The image display apparatus according to claim 4, wherein
the receiver is arranged on each of the four corners.

7. The image display apparatus according to claim 1, wherein
the display unit is a rectangle,
the receiver is at least arranged on a predetermined first corner out of four corners, the four corners being the plurality of adjacent portions, and
the senders are arranged on two corners out of three corners excluding the first corner out of the four corners.

8. The image display apparatus according to claim 1, wherein
the display unit has its top and bottom in use, and
the tops of the display units of the image display apparatus and the other image display apparatus come to the upper side, and the bottoms come to the lower side.

9. The image display apparatus according to claim 5, wherein
the display unit has a long-side direction and a short-side direction, the display unit being capable of being used right side up and upside down, the short-side direction being a vertical direction, and
the receiver is arranged on each of the first and second corners.

10. The image display apparatus according to claim 1, further comprising:
a detector capable detecting an arrangement direction.

11. The image display apparatus according to claim 1, wherein
the senders are RFID (Radio Frequency IDentification) tags, and
the receiver is an RFID reader.

12. An information processing apparatus capable of controlling at least part of operations of a plurality of unit apparatuses,
each of the plurality of unit apparatuses including
a plurality of adjacent portions having a predetermined positional relation,
senders capable of sending data via near field communication, the senders being arranged on at least two of the plurality of adjacent portions, respectively, and
a receiver capable of receiving data via the near field communication from a sender of another unit apparatus, the receiver being arranged on at least one of the plurality of adjacent portions,
the information processing apparatus comprising:
a data receiver configured to receive the data, the receiver of each of the plurality of unit apparatuses receiving the data from the sender via the near field communication; and
a calculator capable of calculating an arrangement status of the plurality of unit apparatuses based on the received data.

13. The information processing apparatus according to claim 12, wherein
each of the senders of each of the plurality of unit apparatuses is capable of sending the data via the near field communication within an area including a vicinal adjacent portion, the vicinal adjacent portion being an adjacent portion in the vicinity of the sender out of a plurality of adjacent portions of the other unit apparatus,
the receiver of each of the plurality of unit apparatuses is capable of receiving data from the sender of the other unit apparatus via the near field communication within the area including the vicinal adjacent portion, the sender being arranged on the vicinal adjacent portion,
the information processing apparatus further comprises a determining unit capable of
determining the other unit apparatus including the vicinal adjacent portion on which the sender is arranged based on the data received by the data receiver, the vicinal adjacent portion being in the vicinity of the adjacent portion on which the receiver is arranged, and
determining a position of the vicinal adjacent portion on which the sender is arranged out of the plurality of adjacent portions of the other unit apparatus, and
the calculator is capable of calculating an arrangement status of the plurality of unit apparatuses based on a determination result of the other unit apparatus including the vicinal adjacent portion determined by the determining unit, and based on a determination result of the position of the vicinal adjacent portion determined by the determining unit.

14. The information processing apparatus according to claim 13, wherein
each of the plurality of unit apparatuses has its top and bottom in use,
the tops of the plurality of unit apparatuses come to the upper side, and the bottoms come to the lower side, and
the information processing apparatus further comprises a detector capable of detecting an upside-down unit apparatus out of the plurality of unit apparatuses based on the determination result determined by the determining unit.

15. The information processing apparatus according to claim 12, wherein
each of the plurality of unit apparatuses includes a detector capable detecting an arrangement direction, and
the calculator is capable of calculating an arrangement status of the plurality of unit apparatuses based on the arrangement direction of each of the plurality of unit apparatuses detected by the detector.

16. An information processing method executed by a computer capable of controlling at least part of operations of a plurality of unit apparatuses,
each of the plurality of unit apparatuses including
a plurality of adjacent portions having a predetermined positional relation,
senders capable of sending data via near field communication, the senders being arranged on at least two of the plurality of adjacent portions, respectively, and
a receiver capable of receiving data via the near field communication from a sender of another unit apparatus, the receiver being arranged on at least one of the plurality of adjacent portions,
the information processing method comprising, by the computer:
receiving the data, the receiver of each of the plurality of unit apparatuses receiving the data from the sender via the near field communication; and
calculating an arrangement status of the plurality of unit apparatuses based on the received data.

17. A program, causing a computer to process information, the computer being capable of controlling at least part of operations of a plurality of unit apparatuses,
each of the plurality of unit apparatuses including
a plurality of adjacent portions having a predetermined positional relation,
senders capable of sending data via near field communication, the senders being arranged on at least two of the plurality of adjacent portions, respectively, and
a receiver capable of receiving data via the near field communication from a sender of another unit apparatus, the receiver being arranged on at least one of the plurality of adjacent portions,
the program causing the computer to execute the steps of:
receiving the data, the receiver of each of the plurality of unit apparatuses receiving the data from the sender via the near field communication; and
calculating an arrangement status of the plurality of unit apparatuses based on the received data.

18. An information processing system, comprising:
a plurality of unit apparatuses; and
a control apparatus capable of controlling at least part of operations of the plurality of unit apparatuses, wherein
each of the plurality of unit apparatuses includes
a plurality of adjacent portions having a predetermined positional relation,
senders capable of sending data via near field communication, the senders being arranged on at least two of the plurality of adjacent portions, respectively, and
a receiver capable of receiving data via the near field communication from a sender of another unit apparatus, the receiver being arranged on at least one of the plurality of adjacent portions, and
the control apparatus includes
a data receiver configured to receive the data, the receiver of each of the plurality of unit apparatuses receiving the data from the sender via the near field communication, and
a calculator capable of calculating an arrangement status of the plurality of unit apparatuses based on the received data.
